(19) United States
(12) Patent Application Publication
(10) Pub. No.: US 2010/0254581 A1
(43) Pub. Date: Oct. 7, 2010

(54) DEVICE, METHOD, AND APPARATUS FOR BIOLOGICAL TESTING WITH A MOBILE DEVICE

(75) Inventors: Jason Neeser, Austin, TX (US); Michael Rasoulian, Austin, TX (US); Damon V. Borich, Austin, TX (US); Robert Eugene Hanes, Austin, TX (US); Thomas A. Harlan, Austin, TX (US)

Correspondence Address: CHALKER FLORES, LLP, 2711 LBJ FRWY, Suite 1036, DALLAS, TX, 75234, US

(73) Assignee: REVEAL SCIENCES, LLC, Austin, TX (US)

(21) Appl. No.: 12/755,688

(22) Filed: Apr. 7, 2010

Related U.S. Application Data
(60) Provisional application No. 61/167,493, filed on Apr. 7, 2009.

(51) Int. Cl. G06K 9/00; H04N 7/18

(52) U.S. Cl. 382/128; 348/77; 348/E07.085

(57) ABSTRACT

Compositions, methods, and systems for the imaging and analysis of skin, hair and associated health conditions are described herein. The system includes a method and apparatus for analyzing skin and hair samples by taking a sample, identifying desired components of the sample, obtaining an image electronically using a mobile consumer device, storing and transmitting the image, analyzing the image using an analysis software on a remote server, and optionally sending the results of the analysis back to the consumer device.

### CROSS-REFERENCE TO RELATED APPLICATIONS

This application claims priority to U.S. Provisional Application Ser. No. 61/167,493, filed Apr. 7, 2009, the entire contents of which are incorporated herein by reference.

### TECHNICAL FIELD OF THE INVENTION

The present invention relates in general to the sample analysis for assessing associated health conditions, and more particularly, to a novel system, method and apparatus for taking a biological sample to assess an associated health condition using a consumer device, including but not limited to mobile devices

### STATEMENT OF FEDERALLY FUNDED RESEARCH

None.

### BACKGROUND OF THE INVENTION

Without limiting the scope of the invention, this invention relates generally to the field of biological sample analysis using mobile devices in order to assess associated health conditions.

United States Patent Application No. 20090075250 (Cumberland et al., 2009) discloses a sampling and testing device for the detection of specific molds, allergens, viruses, bacteria, fungi, and other protein containing substances. Embodiments of the device include a sampling member slideably engaged with a base that contains a lateral flow strip adapted to detect specific analytes of interest. The sampling member defines a solvent reservoir that stores an elution solvent in a fluid-tight manner before the device is used to sample and test environmental surfaces. During slideable withdrawal of the sampling member from the base, the elution solvent stored in the reservoir is automatically released to a wick assembly of the sampling member. The wick assembly includes a wick adapted to receive, distribute, and retain the elution solvent. After a user samples an environmental surface for an analyte of interest with the elution solvent wetted wick, the sampling member is returned to the base where the wick contacts the lateral flow strip contained in the base. The wick transfers at least a portion of analyte and the elution solvent to the lateral flow strip for the calorimetric detection of specific allergens, viruses, bacteria, and other protein containing substances in the sample. The calorimetric results of the test are displayed through a window in the base.

### SUMMARY OF THE INVENTION

The invention relates to a method and apparatus for taking a biological sample to assess an associated health condition. The invention includes an apparatus designed to adapt a hand held consumer device into a diagnostic tool with the capability of collecting a biological sample, processing the biological sample, imaging the biological sample, sending the image to a remote server for image-processing based analysis, the server then returning the analyzed image with a report on a condition or attribute associated with the biological sample taken, then distributes marketing information associated with the test. The marketing information is sent electronically directly to the consumer, through e-mail or in an SMS text message. The location-determining capabilities of the device, such as GPS, may be utilized to distribute localized marketing information.

The instant invention in one embodiment provides a method of testing a surface sample comprising the steps of: collecting the surface sample with a sampling device, capturing at least one digital image with a digital camera of a consumer device of the sample selected from at least one of before, during or after the sample interacts with the one or more agents, transmitting the at least one digital image of the sample over a network to be analyzed by a remote server and analyzing the transmitted the at least one digital image using an image processing software on the remote server. The method as described herein further comprises the steps of inserting the sampling device into the consumer device or an adaptor linked to the consumer device, wherein the consumer device comprises a digital camera, and optionally provides a GPS location, a vibration capability, an image storage memory, and wherein the adaptor comprises a modifier lens to adjust a focal length of the consumer device camera lens, and one or more LEDs positioned to illuminate the sample. Further the method also comprises the optional steps of: retransmitting the analyzed images back to the consumer device to report a test result and providing electronic media marketing materials comprising health and beauty care product, salon, and service recommendations to the consumer device.

In one aspect of the method the sampling device comprises one or more agents disposed to interact with the surface sample. In another aspect the sample comprises at least one of skin, nail, hair, biological fluid, one or more chemical species or any combinations thereof. In a specific aspect the sampling device further comprises one or more membranes selected from nitrocellulose, UVPE, PVDF, hydrophobic membranes known to those skilled in the art of immunosorbent assays. In yet another aspect the sampling device comprises an optional optical barcode, a radio frequency (RF) ID tag or combinations and modifications thereof. The sampling device comprises a disposable card comprised from cardboard or vinyl sized for a cartridge and further comprises a background with a random colored pattern for security, calibration, and test validation interpretable by an algorithm processing digital signal from the digital camera.

The sampling device as described in the method of the present invention is adapted to remove skin cells, proteins, and oils, capture enzymes from a stratum corneum for chemical testing. The sampling device is selected to maximize the imaging capabilities of an imaging device through minimizing, maximizing or mixing reflective, absorbance, and transmittance properties and optionally comprises one of a preloaded region with an analyte specific reagent, such as a synthetic receptor, releases a dye upon experiencing a change in pressure, comprises a chemical composition for indicating health conditions or allows flow to a subsequent surface. In one aspect the consumer device is selected from the group consisting of digital cameras, digital camcorders, mobile phones, camera phones, PDA devices, Blackberry devices, and laptop computers.

Another embodiment of the present invention discloses a method for assessing skin and associated health conditions in a subject. The method comprises the steps of: obtaining a sample comprising hair, skin cells, proteins or enzymes from a stratum corneum of the subject with a sampling device, wherein one or more agents are disposed thereon and interact with the skin. The sample or the backing is placed into a consumer device comprising a digital camera or an adaptor linked to or integrating to a consumer device comprising:
(i) a stationary or mobile housing, a docking station or a combination thereof to enclose or integrate the consumer device temporarily or permanently,
(ii) an area to interface, insert, accept, and process the sample or the sampling device or a sampling area for directly imaging the one or more regions of the skin, wherein the sampling area comprises one or more sensor, light sources, and switches,
(iii) one or more modifier lenses, wherein the modifier lenses adjust the focal length of a digital camera of the consumer device to focus the sample, wherein the lenses comprise a single macro, a micro, a telephoto lens or a combination thereof, and
(iv) one or more LEDs to illuminate the sample;

One or more digital images of the sample are captured with the digital camera of the consumer device. Following capture the digital images of the sample are transmitted over a network to be analyzed by a remote server. The transmitted digital images are analyzed using an image processing software on the remote server and retransmitted back to the consumer device to report the results of the skin and the associated health condition to the subject or a health care professional.

In one aspect of the method disclosed hereinabove the sampling device further comprises one or more membranes selected from nitrocellulose, UVPE, PVDF, hydrophobic membranes known to those skilled in the art of immunosorbent assays. In another aspect the sampling device comprises an optional optical barcode radio frequency (RF) ID tag or combinations and modifications thereof. In yet another aspect the sampling device comprises a disposable card comprised from cardboard or vinyl sized for a cartridge. The sampling device comprises a background with a random colored pattern for security, calibration, and test validation interpretable by an algorithm processing digital signal from the digital camera and is selected to maximize the imaging capabilities of an imaging device through minimizing, maximizing or mixing reflective, absorbance, and transmittance properties. Furthermore, the sampling device optionally comprises one of a preloaded region with an analyte specific reagent, such as a synthetic receptor, releases a dye upon experiencing a change in pressure, comprises a chemical composition for indicating health conditions or allows flow to a subsequent surface.

In one aspect the consumer device is selected from the group consisting of digital cameras, digital camcorders, mobile phones, camera phones, PDA devices, Blackberry devices, and laptop computers and provides a GPS location and a vibration capability. In a specific aspect the consumer device is a mobile phone. In another aspect the LEDs comprise UV, Infrared, white or any other wavelength on the visible light spectrum. In yet another aspect the LEDs are programmed to function optimally from one or more properties of the digital camera of the consumer device comprising speed, color filters or combinations thereof.

The present invention also describes an apparatus design for integration with one or more consumer devices selected from the group consisting of digital cameras, digital camcorders, mobile phones, camera phones, PDA devices, Blackberry devices, and laptop computers to detect a sample captured on a test strip, the apparatus comprising: (i) a stationary or mobile housing, a docking station or a combination thereof to enclose or integrate with the consumer device temporarily or permanently, therein the housing comprises a sample receiving port, (ii) one or more modifier lenses, wherein the modifier lenses adjust the focal length of a digital camera of the consumer device to focus the sample, and (iii) one or more lights to illuminate the sample, wherein the digital camera is capable of capturing one or more images the sample. The apparatus as described in the present invention comprises a single macro, a micro, a telephoto lens or a combination thereof. The lights of the apparatus of the present invention are defined further as comprising one or more LEDs that emit UV, Infrared, white or any other wavelength on the visible light spectrum and that are programmed to function optimally from one or more properties of the digital camera of the consumer device comprising speed, color filters or combinations thereof.

In yet another embodiment the present invention describes a system for assessing a skin and associated health care conditions comprising: a consumer device capable of capturing a digital image, providing a GPS location, and vibration capability selected from the group consisting of digital cameras, digital camcorders, mobile phones, camera phones, PDA devices, Blackberry devices, and laptop computers, an apparatus for integrating with the one or more consumer devices comprising: a stationary or mobile housing, docking station or a combination thereof to enclose or integrate the consumer device temporarily or permanently; a sampling area for directly imaging one or more regions of the skin, wherein the sampling area comprises one or more sensor, light sources, and switches; a modifier lens to adjust a focal length of the consumer device camera lens, and one or more LEDs for illuminating the sample; a port or an interface for transmitting one or more digital images to a remote server, and a remote server for analyzing and optionally retransmitting the analyzed image to the consumer device, wherein the server comprises an image processing and analysis software to analyze the transmitted digital image. The system described hereinabove optionally provides electronic media marketing materials comprising health and beauty care products, salon, and service recommendations to the consumer device

In one embodiment the present invention discloses a method for assessing skin and associated health conditions in a subject comprising the steps of: (i) placing an apparatus integrated with the one or more consumer devices on one or more regions of the skin, wherein the apparatus comprises: a stationary or mobile housing, docking station or a combination thereof to enclose or integrate the consumer device temporarily or permanently; a sampling area for directly imaging the one or more regions of the skin, wherein the sampling area comprises one or more sensor, light sources, and switches; a modifier lens to adjust a focal length of the consumer device camera lens; and one or more LEDs for illuminating the sample, (ii) capturing one or more digital images of the sample with the digital camera of the consumer device, (iii) transmitting the digital images of the sample over a network to be analyzed by a remote server, (iv) analyzing the transmitted digital images using an image processing software on the remote server, and (v) retransmitting the analyzed images back to the consumer device to report the results of the skin and the associated health condition to the subject or a health care professional. The consumer device of the present invention is selected from the group consisting of digital cameras, digital camcorders, mobile phones, camera phones, PDA devices, Blackberry devices, and laptop computers and provides a GPS location and vibration capability. In a specific aspect the consumer device is a mobile phone.

In one aspect of the system disclosed in the present invention the sampling device comprises an optional optical barcode, a radio frequency (RF) ID tag or combinations and modifications thereof. In another aspect the sampling device comprises a disposable card comprised from cardboard or vinyl sized for a cartridge. In yet another aspect the sampling device comprises a background with a random colored pattern for security, calibration, and test validation interpretable by an algorithm processing digital signal from the digital camera. The sampling device of the system is adapted to remove skin cells, proteins, and oils, capture enzymes from a stratum corneum for chemical testing and is selected to maximize the imaging capabilities of an imaging device through minimizing, maximizing or mixing reflective, absorbance, and transmittance properties. In one aspect the sampling device optionally comprises one of a preloaded region with an analyte specific reagent, such as a synthetic receptor, releases a dye upon experiencing a change in pressure, comprises a chemical composition for indicating health conditions or allows flow to a subsequent surface.

Another embodiment of the instant invention discloses an adhesive composition for removing proteins, hair, skin cells, and oils or capturing enzymes comprising an adhesive for removing the stratum corneum in different thicknesses for chemical testing. The composition comprises one or more membranes selected from nitrocellulose, UVPE, PVDF, hydrophobic membranes known to those skilled in the art of immunosorbent assays. In one aspect the adhesive is selected to maximize the imaging capabilities of an imaging device through minimizing, maximizing or mixing reflective, absorbance and transmittance properties. In another aspect the adhesive substance embedded with a functional chemical for enhancing the image of a collected sample and comprises an optical dye that emits in the visible range and selectively interacts with protein, oxidized protein or lipids. In yet another aspect the adhesive comprises natural adhesives synthetic adhesives, drying adhesives, contact adhesives thermoplastic adhesives, reactive adhesives, UV, and light curing adhesives or pressure sensitive adhesives.

In one aspect the adhesive comprises chemical and physical properties that detector one or more chemical species in the skin, is optimized for optical imaging, illuminated from LED's in the IR, visible, and UV wavelengths. In another aspect the composition of the instant invention comprises one or more indicating dyes, buffers and activators for indicating the presence of skin markers. In yet another aspect the adhesive comprises dyes, buffers and activators for highlighting a group of skin properties such as moisture, dryness, irritation, wrinkles or sun damage. In related aspects the adhesive comprises two or more adhesives selected are porous, hydrophilic, hydrophobic, double-sided, and hydrogels, captures topographical information from the surface to which it is attached, and comprises one or more agents that simultaneously monitors pH, moisture content, and oil.

The composition as described hereinabove further comprises an agent that disrupts cell membranes and one or more reagents selected from: a buffer, a dye, an activator a synthetic receptor or linker. In one aspect the composition is placed in one or more regions of a backing or a test strip for imaging skin and assessing skin and associated health conditions. In another aspect the test strip or the backing is placed in an apparatus or an adaptor integrated with one or more consumer devices. In yet another aspect the consumer device is capable of capturing a digital image, providing a GPS location, and an anti-vibration capability selected from the group consisting of digital cameras, digital camcorders, mobile phones, camera phones, PDA devices, Blackberry devices, and laptop computers.

### BRIEF DESCRIPTION OF THE DRAWINGS

For a more complete understanding of the features and advantages of the present invention, reference is now made to the detailed description of the invention along with the accompanying figures and in which:

FIG. 1 shows the reaction of mildly green fluorescent epicocconone with nucleophilic amines in proteins to produce a strongly red fluorescent complex;

FIG. 2 shows a carbonylated protein reactive dye would be one that emits in the blue region when excited at 365 nm: 7-diethylaminocoumarin-3-carboxylic acid hydrazide;

FIG. 3 shows a tape strip of firm but flexible composition would include several separate and diverse regions isolated by thin films;

FIG. 4 shows a tape strip of firm but flexible composition would include several separate and diverse regions isolated by thin films;

FIG. 5 shows an example of a unique identification pattern for use with the present invention;

FIG. 6 shows a test strip designed to sample a surface with two or more adhesive regions

FIG. 7 shows that carbonylated proteins can then be imaged and analyzed the reader system and software program;

FIG. 8 is an example of make-up analysis test assessing amount of coverage; and

FIG. 9 is a graph of an untreated forehead treated with an exposure to white LEDs at 20 s intervals for 20 minutes;

FIG. 10 are images showing various percentages of hydration of a cheek treated with an exposure to white LEDs at 20 s intervals for 10 minutes;

FIG. 11A is a graph showing the percent hydration of an untreated cheek treated with an exposure to white LEDs at 20 s intervals for 10 minutes;

FIG. 11B is a graph showing the percent hydration of a cheek treated with Aveeno SPF70 treated with an exposure to white LEDs at 20 s intervals for 10 minutes;

FIG. 12A is a graph showing the percent hydration of an untreated forehead treated with an exposure to white LEDs at 20 s intervals for 20 minutes;

FIG. 12B is a graph showing the percent hydration of a forehead treated with a high-end moisturizer treated with an exposure to white LEDs at 20 s intervals for 20 minutes;

FIG. 13A is an image of phone, apparatus with an adhesive strip inserted;

FIG. 13B is a back view of phone placed in the apparatus;

FIG. 13C is an image of phone screen showing analysis results further scrolled down. Results show hydration level quantification based upon image analysis of the dry skin on the adhesive test strip placed in the holder;

FIG. 13D is an expanded view (close up) of the image shown in FIG. 13C;

FIG. 14 is a prototype of an enclosed consumer adaptive apparatus as described in the present invention;

FIGS. 15A and 15B are Smart phone modifier for imaging test strips. CAD drawings of apparatus which modifies the iPhone to be capable of taking images of tape strips. The lens in the apparatus modifies the focal length of the iPhone camera to be able to clearly focus on the sample. A white LED illuminates the sample when it is inserted;

FIG. 16 is an apparatus with iPhone inserted and iPhone app on display;

FIG. 17A is a Smart phone modifier for imaging skin directly. The apparatus is similar to apparatus in FIGS. 15A and 15B except the front face of apparatus is open to allow for direct image of skin. The drawing shows two light sources, two switches, a sensor and a modifier lens;

FIG. 17B is another angle of apparatus embodiment shown in FIG. 17A. This apparatus would allow for analysis of various skin conditions and features, such as moles, acne, skin diseases, pigmentation, and sun damage. In addition to skin, the device could analyze other features such as teeth, gums and hair;

FIG. 18 is a Smart phone modifier with communication port interface;

FIG. 19 shows two applications apparatus shown in FIGS. 17 and 18. Application 2 uses a UV LED light source to take an image of the subjects face. This allows for viewing features below the surface of the skin, such as sun spots and skin damage;

FIGS. 20A and 20B show UV/Sunscreen experimentation using apparatus with UV LEDs as light source and tape strips as medium;

FIG. 21 is a schematic overview of mobile acquisition network, where the novel apparatus is used to capture a biological/chemical sample and transmit it through the network; and

FIG. 22 is one example of a method of care and system using the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Generally, all technical terms or phrases appearing herein are used as one skilled in the art would understand to be their ordinary meaning.

Consumer devices can be hand-held and compact so that they can fit into a consumer's wallet and/or pocket (e.g., pocket-sized). For example, the portable consumer devices may include smartcards, ordinary credit or debit cards (with a magnetic strip and without a microprocessor), a keychain device (such as the Speedpass commercially available from Exxon-Mobil Corp.), etc. Other examples of consumer devices include cellular phones, personal digital assistants (PDAs), pagers, payment cards, laptop computers, Blackberry devices, digital cameras, digital camcorders, Blackberry devices, security cards, access cards, smart media, transponders, RFID flexible tags, and the like. Such portable consumer devices can have one or more antennas that can transmit and/or receive signals and data through a wireless communication medium. A consumer device may include a memory such as a memory chip and/or a microprocessor.

The term “mobile phone” as used herein refers to a telephone handset that can operate on a cellular network, a Voice-Over IP (VoIP) network such as Session Initiated Protocol (SIP), or a Wireless Local Area Network (WLAN) using an 802.11x protocol, or any combination thereof.

The term “digital camera ” denotes any camera that includes as its main component an image-taking apparatus provided with an image-taking lens system for forming an optical image, an image sensor for converting the optical image into an electrical signal, and other components, examples of such cameras including digital still cameras, digital movie cameras, and Web cameras (i.e., cameras that are connected, either publicly or privately, to a device connected to a network to permit exchange of images, including both those connected directly to a network and those connected to a network by way of a device, such as a personal computer, having an information processing capability).

The term “remote server” as used herein refers to a process on a computer system that is communicated with over a network. The term “GPS” is intended to encompass any satellite based navigational system. As used herein, the term “LED” refers generally to light emitting diodes of all types, but also should be understood to include any kind of similar system that is capable of receiving an electrical potential and producing a color of visible or ultraviolet (UV) light in response to the resulting electrical current. LED also include such systems as light emitting diodes, semiconductor dies that produce light in response to current, organic LEDs, electro-luminescent strips, silicon based structures that emit light, and other such systems within the term “LED”.

The term “stratum corneum ” is used herein in its broadest sense to refer to the outer layer of the skin, which is comprised of (approximately 15) layers of terminally differentiated keratinocytes made primarily of the proteinaceous material keratin arranged in a ‘brick and mortar’ fashion with the mortar being comprised of a lipid matrix made primarily from cholesterol, ceramides and long chain fatty acids. The stratum corneum creates the rate-limiting barrier for diffusion of the active agent across the skin. The term “skin cells” keratinocytes, melanocytes, fibroblasts, Merkel cells and Langerhans cells.

As used herein the terms “protein”, “polypeptide” or “peptide” refer to compounds comprising amino acids joined via peptide bonds and are used interchangeably. A “polypeptide” is a polymer of amino acid residues joined by peptide bonds, whether produced naturally or synthetically. Polypeptides of less than about 10 amino acid residues are commonly referred to as “peptides.” A “protein” is a macromolecule comprising one or more polypeptide chains. A protein may also comprise non-peptidic components, such as carbohydrate groups. Carbohydrates and other non-peptidic substituents may be added to a protein by the cell in which the protein is produced, and will vary with the type of cell. Proteins are defined herein in terms of their amino acid backbone structures; substituents such as carbohydrate groups are generally not specified, but may be present nonetheless.

A variety of unique methods have been discovered and invented to collect and sample biological materials for diagnostic and analytical purposes. This invention is directly related to sampling of biological mediums such as skin and hair by utilizing existing sampling techniques, i.e. adhesive membranes, in combination with novel chemistry assay technology.

The present invention includes the ability to apply novel color-changing, multi-functional and analyte binding reagents and dyes with adhesive sampling methods to achieve an integrated non-invasive skin sampling diagnostic assay.

The present invention describes a mobile consumer imaging and processing system for analysis of skin, hair and associated health conditions. In addition methods and compositions for obtaining biological samples and identifying desired components of the sample are also described. The consumer devices of the instant invention comprises a digital camera, provides a GPS location, and an anti-vibration capability and are selected from the group consisting of digital cameras, digital camcorders, mobile phones, camera phones, PDA devices, Blackberry devices, and laptop computers. The invention also describes an apparatus or an adaptor that integrates with the above-mentioned consumer devices. The apparatus is capable of directly imaging regions or portions of the skin or is designed to accept an adhesive tape strip or a backing used for collecting the biological sample.

Processing and Analysis of Surface Samples. Surfaces contain important information in that they are the first barrier to penetration (e.g., skin), they typically reflect the greatest environmental effects, and they contribute strongly to a viewer's aesthetic interpretation. Consequently, numerous sampling techniques have been developed, including those that use adhesive devices, swabs, and absorbent pads. These sampling techniques may also incorporate pre-processing of the surface, pre and post-processing of the sampling device, and several forms of detection and analysis to accentuate desired parameters. The present invention includes new surface sampling techniques and applications, especially for skin and hair. The tape strip or swab themselves become a vehicle for delivery of buffers, reagents, dyes, chelators, and filtration agents, as well as a support surface for the necessary processes and reactions to occur. All these components expose, react, separate and detect chemical and biological markers and analytes that may be correlated to, for example, various skin and hair conditions, treatment regimens, product usage parameters, environmental exposures and various aesthetic and medically relevant parameters.

As used herein, the term “surface samples” refers to any surface, whether a top surface or layer or surfaces or layers that are exposed subsequent to some form of processing, e.g., scraping, cleaning, abrasion, peeling (mechanical, chemical, etc.). Surfaces are not limited merely to existing surfaces but also include newly derived or exposed surfaces. For example, in the case of multi-tape tape stripping on the same location, with each skin sample removed, the newly exposed skin layer would become the new surface. As another example, both a sample of an apple's exterior as well as a sample of an apple's interior when cut open would be considered surface samples as applied to this invention.

The present invention includes pigments, dyes, or chelators that can be used on surface samples in order to accentuate certain parameters, label analytes, or bind analytes. As required for these applications, buffers, reagents, heating or cooling, and mixing would also be incorporated.

There are many potential areas of use for such a skin and hair analysis system: a) medical spa industry, which offers aesthetic services such as laser-therapy, Botox, chemical peels, hair-removal, etc.; b) salons, spas, and resorts that offer products and treatments such as facials, wraps, peels, and full body treatments, etc.; and c) health & wellness specialists that tender homeopathy, naturopathy, chiropractic, and herbal medicine; d) dermatologists; e) aestheticians; and f) pharmacy retailers (compounding or retail chains). The present invention provides health care professionals information about the consumer/client/patient's skin or hair that will be useful in choosing the appropriate skin or hair care products to remedy the condition or improve quality of skin and health. Another potential area the skin and hair analysis system would be useful is at the beauty counter of high-end retailers and department stores where personal care and cosmetic products are sold. The present invention may also be useful to industry, clinical research companies, and ingredient manufacturers. Most notably, the consumer will benefit.

Current methods for analyzing skin are: 1) imaging or 2) determination of physical factors. For example, current methods for determining appearance of skin, fine lines, wrinkles, ageing, sagging and UV damage are mostly visualization of the face by various imaging apparatus. Visual images range from a basic or magnified photograph to three-dimensional (3-D) optically enhanced images. Most of these images can be self-assessed or graded visually by an expert during a consultation in salons, medical spas or by dermatologists. Scopes and sensors are the most widely used imaging devices. Typically, these systems consist of a camera that magnifies skin and pores, and a sensor that measures oil, hydration and elasticity of the skin. Commercial examples are the etude and i-scopeUSB made by the company Moritex. Skin appearance, oiliness, dryness, elasticity, texture, pigmentation, and squames are analyzed. Another example is 3-D imaging, which is more expensive but not much more sophisticated in terms of information provided to the customer/client/patient.

Various other methods exist to determine physical factors such as skin hydration, elasticity, and barrier function. Skin hygrometers are type of apparatus that measure electrical capacitance and conductance of skin in order to determine the skin's relative hydration. Hydration has also been measured via spectroscopy, including acoustic, infrared, and Nuclear Magnetic Resonance (NMR), and corneometry. Skin elasticity is often measured using a ballistometer, dermal torque meter, or by pinch recoil. Skin barrier function and water evaporation are usually measured by transepidermal water loss (TEWL). Most of these methods for evaluating skin parameters are used in clinical efficacy trials and would not work at beauty counter in a retail distributor or in the medical spa or salon. The present invention provides for such application. The user can determine efficacy of particular ingredients and correlate results to definite biomarkers.

Current methods for determining skin type range from customers completing inclusive questionnaires to non-invasive methods. Currently available methods for determining skin condition do not provide adequate information to determine the cause of skin conditions. This approach is very subjective and relies on the customer's answers. Preconceived notions and inaccurate information will vary the answers and are not very helpful in assessing actual conditions. Most of the skin conditions or biomarker are non-visible and cannot be determined readily by visual assessment or answering a few subjective questions. The present invention reveals the underlying biomarkers and the causes of skin conditions or problems, which provides for specific personal care.

Tape-stripping is a non-invasive approach that permits a direct quantitative and qualitative assessment of biomarkers from the skin surface and stratum corneum (SC). Examples of tape-stripping products commercially available are D-Squame (CuDerm), Sebutape (CuDerm), various adhesive and mailing tapes (3M), and cyanoacrylate resin. Samples are taken by applying the adhesive tape to a target area of skin in a manner sufficient to isolate an epidermal sample adhering to the adhesive tape. Layers of the SC can be sequentially removed by repeated application of pieces of adhesive tape. The epidermal sample contains biomarkers that correlate to skin conditions. Currently, tape-stripping is used in research or for marketing. These methods give varying degrees of qualitative information, but do not offer any way of detecting specific biomarkers or skin analytes linked to various skin conditions. For instance, an apparatus can determine that skin is dry or less elastic. However, the apparatus does not give the consumer a reason for the dryness or loss of elasticity. The present invention correlates biological markers to skin or hair conditions.

Abundance of biomarkers correlating to skin conditions exemplify why it is currently difficult to coordinate products to consumer skin conditions. Stratum corneum is the outer layer of the skin that interacts with the environment. Biomarkers naturally occurring in the stratum corneum are natural moisturizing factors (NMFs), proteins, enzymes, lipids, fatty acids, ceramides, and cytokines The presence of aldehydes, carbonyl proteins, vitamins, surfactants, metals, pollutants, porphyrins, and bacteria are indicative of various skin conditions. Imbalance of naturally occurring biomarkers or the presence of one or more analytes correlate to skin conditions including, but not limited to dryness, itchiness, flaking, scaling, roughness, wrinkles, elasticity, age spots, bumps, redness, and inflammation. These skin conditions are implicated in several skin problems or diseases, such as oxidative or sun-damage, dehydration, acne, irritation, aging, wrinkles, inflammation, rosacea, eczema, psoriasis, and allergic or contact dermatitis.

Natural moisturizing factors molecules are generated by hydrolysis of the protein filaggrin into free amino acids. NMFs are implicated in skin conditions such as dryness, flaking, scaling, inflammation, and ageing. Numerous proteins are found in stratum corneum, such as keratin, corneodesmosin, loricrin, suprabasin, desmoglein, and others. It is further well known in the art that oxidative stress causes: 1) oxidative cleavage of proteins; 2) direct oxidation of amino acids; 3) carbonyl groups introduced into proteins via reactions with aldehydes derived from degradation of lipid peroxides. Increased carbonyl protein levels correlate to dryness, scaling, roughness, wrinkles, loss of elasticity, and ageing. Furthermore, aldehydes in cigarette smoke cause damaging carbonyl formation in skin.

Vitamins, derivatives, forms and complexes. UV exposure and oxidation cause a decrease in the human SC's natural anti-oxidants such as vitamins A, C, and E (in various derivative, forms and complexes). Enzymes found in the stratum corneum include, but are not limited to beta-glucocerebrosidase, phospholipases, acid phosphatase, serine proteases: trypsin (chymotrypsin), cholesterol sulfatase, sphingomyelin deacylase, prosaposin, transglutaminase, peptide methionine sulfoxide reductases, and acid ceramidase. Cholesterol esters and cholesterol sulfate are part of the stratum corneum barrier function. Many analytes or biomarkers interact with each other in various synthesis and degradation pathways. For example, Ceramide EOS (Cer(OS)) main ceramide component of stratum corneum. It contains an omega-hydroxy fatty acid ester-linked to linoleic acid and amide-linked to sphingosine. Free linoleic acid is necessary to maintain skin barrier function, and as such altered levels correlate to dry skin, scaling and inflammation.

The presence of unusual species is an indicator of skin conditions. Presence of ω-hydroxy acid, stimulates ceramide production in the epidermis, and can be correlated to scaling and inflammation. Ceramide(AS) is an unusual species and is correlated to dry, itchy, scaling, roughness, bumps and inflammation. Triglycerides, short-chain saturated fatty acids and unsaturated fatty acids are sebaceous contaminants whose presence may serve to disrupt barrier organization at skin surface correlated to dry skin. Phospholipids should not be present in healthy stratum corneum. Cytokines are known to cause wrinkles, redness, and inflammation. Several interleukins have been detected on the skin surface. For example: IL-8, IL-6, IFN-γ, IL-4, IL-13 cause inflammation. Surfactants are known to bind to stratum corneum proteins and cause dry, itchy skin, scaling, roughness, loss of elasticity, bumps, and inflammation. Metals such as nickel are irritants that can cause bumps, redness and irritation. (Nyren, Kuzmina, & Emtestam, 2003). Acne is caused by various factors, including excessive sebum and poor desquamation of the stratum corneum. Indicators are bacterial contamination (P. acnes) and porphryins secreted by bacteria (coproporphyrin I, coproporphyrin III, and protoporphyrin). Dihydrotestosterone (DHT) is a hormone that has also been correlated to oily skin, bumps, redness, inflammation. A decrease in the hormone estrogen causes dryness and wrinkles This condition often occurs during the aging process.

The present invention is used to obtain quantitative data as well as qualitative imaging; broad spectrum of test measures, such as novel biochemical assays, measure custom markers by product, and design by skin condition; product performance indications; product selection information for consumer/product matching with a quick; simple system; and at a lower cost than 3-D imaging. By identifying non-visible skin health markers, more information is given to the professional and consumer enabling more product sales, more product specialization, improving consumer confidence in a product, improving skin health and increasing brand support for manufacturers.

The invention provides a method enabling analysis of skin and hair samples of a person, the method including a step of taking a skin or hair sample. A chemical reagent for identification of specific components in the sample may be added. At least one image is taken with one or more light sources; and non-visible spectrum light captures the image electronically. A memory device will store the image, which can be analyzed and displayed immediately or stored for later processing and display. In one embodiment, the present invention comprises a reader device, disposable test trips or cartridges, and a computer-implemented system to provide a product feedback method.

Skin samples are taken by tape-stripping method and incorporated into a carrier such as a cartridge or test strip. Cartridges or test strips will detect various analytes or biomarkers that correlate with various skin conditions, including but not limited to:

I. Aldehydes, carbonyl proteins, and decreases in vitamin E levels are indicative of skin oxidation and products containing anti-oxidants, sun protection, vitamins should be recommended;

II. Depletion in NMF, ceramides, and varying levels of skin surface enzymes are indicative of dry skin and products such as moisturizers, soaps, and ceramide production enhancers should be recommended;

III. Presence of porphyrins or excessive sebum (oil) coupled with poor desquamation are indicative of acne and products containing salicylic acid, benzoyl peroxide, Retin-A along with specific skin care regimens should be recommended;

IV. Surfactants, metals (Ni²⁺), pollutants and allergens can cause redness or irritation of the skin and the appropriate chemical and natural peels, masks, and detoxification products should be recommended;

V. Ceramides, carbonyls, aldehydes, and collagen levels all relate to skin aging and wrinkles and products with collagen-enhancing treatments, peptides, sunscreen, anti-oxidants, Botox, or surgery should be recommended; and

VI. New analytes, specifically requested analytes, or ingredients will be incorporated into new cartridges (can correlate analyte to new products being developed for research and product feedback).

At least one or more of these cartridges are inserted into a reader device. Images are captured of the skin sample. Another embodiment is to incorporate chemicals into the cartridge or test strip that will react with the skin sample. The software will have algorithms to correlate biomarkers in the skin sample with skin conditions. A report will be generated for the professional or consumer who can then recommend various products relating to the skin condition.

UVA and UVB sunrays, peroxide attack, Michael or Schiff reactions with aldehydes resulting from lipid peroxidation, and other oxidative mechanisms contribute to the oxidation of proteins, to produce carbonylated proteins, in the stratus corneum. Such oxidation can interfere or impede the performance of the protein, eventually contributing to premature ageing, dehydration, and general unhealthiness of the stratus corneum. For this reason, cosmetic research and development as well as choice of cosmetic products must consider the level of carbonylated proteins. A good reference is the ratio of carbonylated to total protein.

An efficient analysis of stratus corneum samples for this ratio therefore becomes necessary. In the case of a non-invasive adhesive sample, for instance, a tape strip, simultaneous analysis of the layer of skin removed for carbonylated proteins versus total proteins would minimize error due to sampling variations, such as location of the tape strip on the skin, layer of skin, application pressure on the tape strip, removal speed and angle, etcetera. For efficiency, the number of reaction or loading steps and washes should be minimized. A fluorescence assay fulfills these requirements, along with giving nanogram sensitivity necessary to such a small amount of sample.

Carbonylated Protein Assays. Since the carbonyls in carbonylated proteins are frequently aldehydes and ketones, an amine linked to a fluorophore as a Schiff reagent becomes the obvious choice for a carbonylated protein assay. The linkage typically involves a hydrazide, semicarbazide, carbohydrazide, and thiosemicarbazides, although sometimes aniline-based fluorophores suffice. Some examples of these dyes are fluorescein-5-thiosemicarbazide, 7-diethylaminocoumarin-3-carboxylic acid hydrazide, Texas Red hydrazide, and 7-amino-4 methylcoumarin. To perform this assay, the adhered sample is immersed in the reactive dye buffer until reaction is complete. None of these fluoropohores is non-fluorescent prior to reaction nor do they significantly shift in emission wavelength upon reaction, so a wash step, typically with phosphate buffered saline, must ensue.

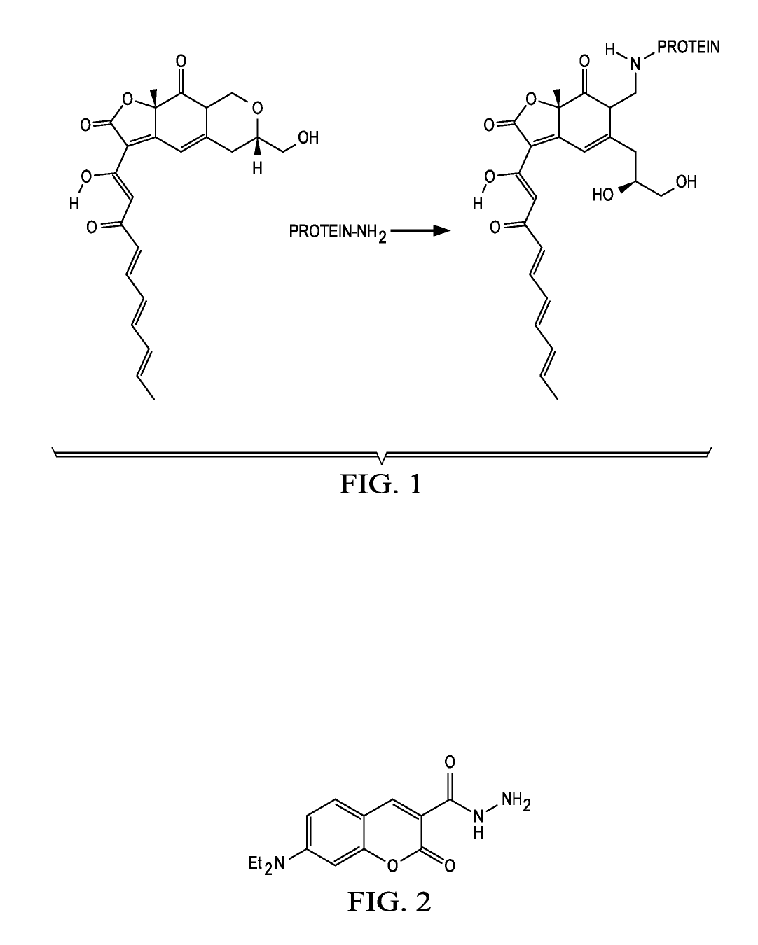

The total protein fluorescent assay of choice FluoroProfile, supplied by Sigma-Aldrich, results from the reversible reaction between virtually non-fluorescent epicocconone with nucleophilic amines on the protein to yield a red-orange emitting fluorophore with an excitation maximum at 390 nm and an emission maximum at 605 nm (FIG. 1). The FluoroProfile assay exhibits a linear range of 40 ng to 200 ug per milliliter of protein and a coefficient of variance among different proteins of 16%, as compared to 11% for the less sensitive, smaller linear range colorimetric BCA assay. To perform the assay, the adhered sample is simply immersed in the epicocconone buffer until reaction is complete. No washing step is necessary. FIG. 1 shows mildly green fluorescent epicocconone reacts with nucleophilic amines in proteins to produce a strongly red fluorescent complex.

Other total protein fluorescent assays include non-fluorescent fluorescamine and o-phthaldehyde. Again, nucleophilic amines in the protein react to produce fluorophores. These two assays exhibit a greater coefficient of variance among proteins as well as a smaller dynamic range, when compared to FluoroProfile.

Due to the interactivity of epicocconone and fluorescent hydrazides and to the FluoroProfile's assay not needing a rinse, the logical order of the assays follows. First are the carbonylated protein assay, a rinse, and then the total protein assay. Simultaneous imaging demands that both assays' fluorophores be excited at the same wavelength. For a UV LED excitation of 365 nm, the total protein epicocconone protein complex emits at 605 nm. To ensure as little spectral overlap as possible, one non-limiting choice for the carbonylated protein reactive dye would be one that emits in the blue region when excited at 365 nm, e.g., 7-diethylaminocoumarin-3-carboxylic acid hydrazide (FIG. 2), which emits at 468 nm. Performing both assays on the adhered samples, quantifying the amount of blue and red fluorescence by image analysis, correcting for spectral overlap and other interferences, and taking a ratio of the corrected blue over corrected red yields the oxidized to total protein ratio.

An in-exhaustive list of composition classes that can be utilized to this end include: colored adhesives, adhesives comprising natural adhesives synthetic adhesives, drying adhesives, contact adhesives thermoplastic adhesives, reactive adhesives, UV and light curing adhesives or pressure sensitive adhesives.

The adhesives physical properties are optimized for optical imaging, illuminated from LED's in the IR, visible and UV wavelengths.

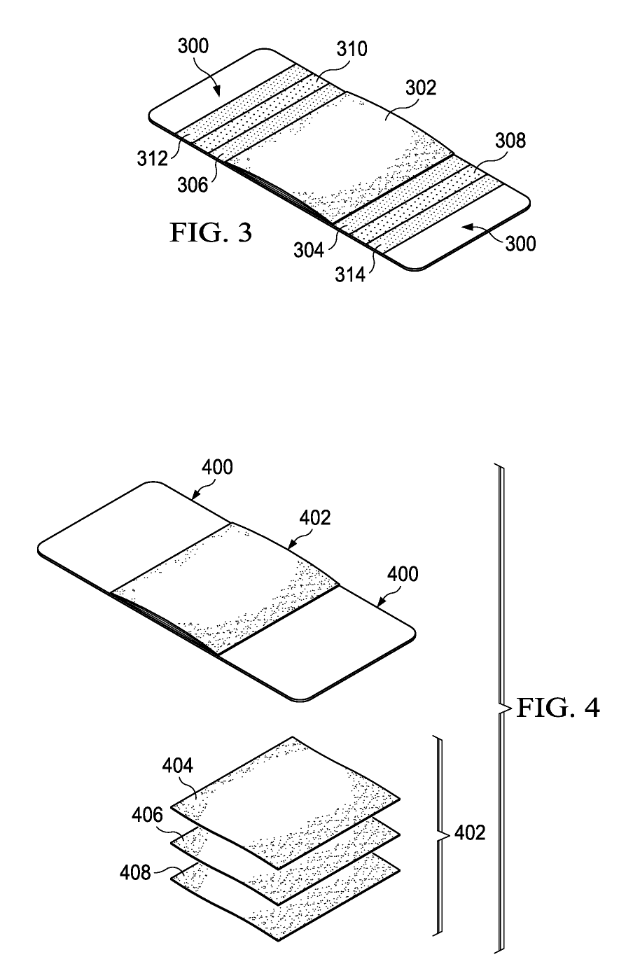

In one embodiment, a tape strip of firm but flexible composition would include several separate and diverse regions isolated by thin films (FIGS. 3 and 4). FIG. 3 shows a backing 300 that may include one or more regions, e.g., an adhesive region 302, a region that includes as an active agent a receptor 304, an activator 306, a filter 308, a dye 310, a buffer 312, an a functionalized material 314 (e.g., an agent that binds to one or more components suspected of being in the surface sample. The most obvious region is that of the adhesive 302 that is applied to a surface such as skin to remove a sample.

FIG. 4 shows another embodiment in which layers of soluble films 402 are arranged vertically on the backing or strip 400. Other regions would comprise buffers, reagents, dyes or pigments, filters, and chelators. In most embodiments, the components of each region would be solids, gums, or hydrogels that would be fixed into place by the thin films. The components could be the necessary compounds themselves, solutions of the compounds that had been evaporated or lyophilized to solids or gums, or hydrogels that incorporate the compounds. The regions on the tape strip would typically be separate, as necessary to prevent premature mixing, with perhaps the most mutually sensitive regions as far apart as possible on the strip. The surface area of the region would consider ease of manufacture, concentration of reagent, and solubility of the reagent. In the simplest conformation, the regions would be parallel to the adhesive region 302 (FIG. 3). However, another conformation adopting vertical separation of regions via soluble films (404-408) (FIG. 4) could be advantageous when a region must be exposed in a particular order or with a particular time delay.

Alternatively and in conjunction with above descriptions of tape strip layout and adhesive compositions, the backing and other material contained can be functionalized to improve other parameters that augment processes such as imaging and optical interrogation or physical manipulation of the sample collected. These include but are not limited to: thermochromic background, tropochromic background, fluorescent background, translucent/transparent background, electrochromatic background, solvochromic background, reflective background, phosphorescent background. Assays surfaces include membranes recognized by one skilled in the art including the compositions nitrocellulose, UVPE, PVDF, hydrophobic membranes known to those skilled in the art of immunosorbent assays.

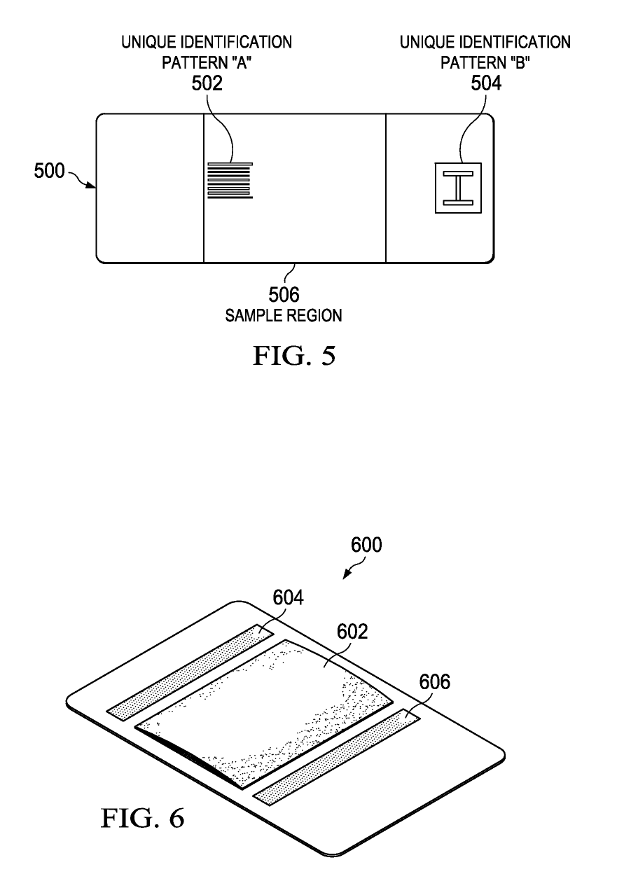

In one embodiment a tape composition includes a background with a random colored pattern for security, calibration and test validation interpretable by a software algorithm that processes the digital signal from a camera. In another embodiment an adhesive region 506 with an optical barcode 502, a decal, or another printed unique identification pattern 504 is interrogated by the imaging system as a method to inhibit naked-eye viewing or to prevent reading by a different imaging system (i.e. requiring the user to use the automated instrument) FIG. 5.

In one embodiment an adhesive system contained on a tape strip 600 comprising 7-diethylaminocoumarin-3-carboxylic acid hydrazide and epicocconone is used to collect a skin sample and carbonylated vs. total protein is indicated and imaged to measure to skin damage and oxidization. In one example, a tape strip 600 contains an adhesive region 602 and two more separate dye containing regions 604 and 606, laid out as shown FIG. 6. A first composition on the test strip in 604 for example, is a thin film comprising 7-diethylaminocoumarin-3-carboxylic acid hydrazide. This thin film can be designed to be soluble in aqueous buffer. Other release paradigms involve a thermo-sensitive film such that an onboard exothermic reaction zone or external heating source dissolves and releases the dye in the film. Upon release 7-diethylaminocoumarin-3-carboxylic acid hydrazide binds to the total protein content contained in the adhesive sample zone 606. After a rinse buffer such as phosphate buffered saline is passed over, a second reagent containing thin film on the adhesive 602 is dissolved to, perhaps by the PBS passed over in the rinse step or other means, releasing the epicocconone that specifically binds to carbonylated proteins in the adhesive sample zone (602). The test strip 600 is then imaged to capture a carbonylated vs. total protein measurement to indicate skin damage and oxidation.

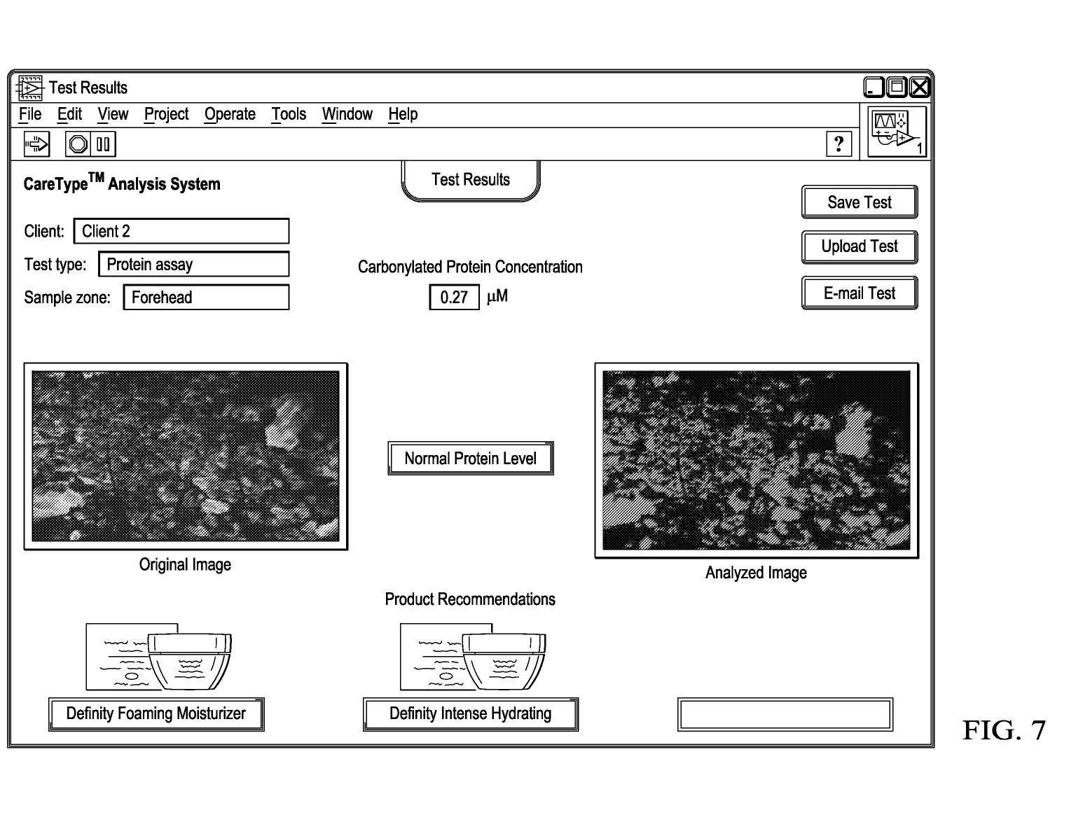

The release of the staining dyes could be accomplished through many different variations according the above listed tape strip arrangements, materials, and compositions provided it meets the following parameters: 7-diethylaminocoumarin-3-carboxylic acid hydrazide is first passed over the sample zone at pH 5.5. The excess 7-diethylaminocoumarin-3-carboxylic acid hydrazide is the rinsed away, and the epicocconone is then passed over the sample zone. Carbonylated proteins can then be imaged and analyzed the reader system and software program as show in FIG. 7. FIG. 7 shows a carbonylated protein assay using fluorescent imaging.

The cartridge has the following functionalities that are modularized: an integrated on-board reagent module that is capable of storing pre-loaded fluids, powders, gels, films, encapsulated particles and the like in single or multiple separated regions, in such a fashion that upon activation the reagents are released in a controlled fashion and allowed to flow to the next module using manual pressure, gravity, wicking materials, hydrophobic/hydrophilic surface gradients, thermal expansion and/or gas driven forces.

Examples of reagents and buffer fluids used to expose skin and hair samples include: ph buffers, lysing agents, skin dissolving chemicals, enzymes, antibodies, antigens, analyte specific reagents, colorants, dyes, two-part dye compounds, nano-particles, and other functionalized materials that are sufficiently dissolvable or flowable.

A sample module, whose primary role is to accept and sufficiently isolate a variety of solid, liquid, matrix bound samples and aliquots and in so doing allow or provide sufficient reaction interface with on board reagents. This module, in one embodiment, would accept chemically functionalized adhesives that have been specifically utilized to collect, through adhesive properties, skin surface compounds, cells, exudates, naturally and artificially applied compounds, chemicals and chemical, biological and reactive and invert substances.

This sample module would be removable, replaceable and capable of being easily sealed (hermetically or otherwise) in a manner to contain the on-board reagents and intro sample, ex tape strip, so that manual shaking, agitation, heating, diffusion, mixing, dissolution, and enzymatic degrade and catalysis may occur in situ. In the case of a tape strip, the tape strip would be placed into the sample module and a reactive dye, for example, would be introduced from the reagent module, and allowed to sufficiently spread, interface, absorb, and react with skin cells and compounds present on the tape strip. These reagents would either provide direct coloration of the tape strip in the form of colorimetric, fluorescent, chemiluminescent, or otherwise optically interrogatable evidence that a reaction has occurred, or they would provide said colorimetric changes to the accompanying fluid, gel or reagent matrix.

The sample module is designed in such a manner as to be transparent in at least one region such that upon insertion of the entire cartridge into the instrument, the sample module may be continually or intermittently optically interrogated or monitored.

A secondary detection module designed in such a fashion as to allow reacted fluids and flowable products from the sample module to collect and aggregate in a region separate and distinct from the actual sample surface. This may be used for secondary sample analysis and detection and purification, amplification, separation. This detection module may be a singular well or group of wells that contain functionalized materials such as region bends, coated walls, selectively absorption matrices or optically reflective absorption properties to enhance, verify and or calibrate the optical interrogation process.

This detection module may also be fitted with optical fitters in between the detection device and the detection regions, in a manner so as to block, concentrate, control specific wavelengths of light transmitted to a reflected out of the detection region.

Additionally, this detection region may include, as part of the cartridge design, an integrated light source ranging from 200-900 that provides illumination to the individual detection regions (wells) and allows the user to directly view the associated color-changes with or without an automated reader device. This internal illumination may also be utilized as a reference calibration or control for determining sample volume, turbidity, particle size/content or may simply save as additional illumination that can be used in conjunction with the automated systems. Control of the cartridge based illumination may be provided by electrical connections that respond to “wetting” automatically as a result of fluid entering the region or may be controlled by cartridge insertion into the reader of other standard electromechanical means (switch etc.)

A final sample collection module that collects ex reagents and fluids for the purpose of providing a wicking “sink” to stimulate continuous controlled flow throughout the fluidic system and to provide a sealed, controlled recovery of fluids, compounds, DNA, RNA and other chemically and biologically relevant compounds for disposal or secondary off-cartridge analysis.

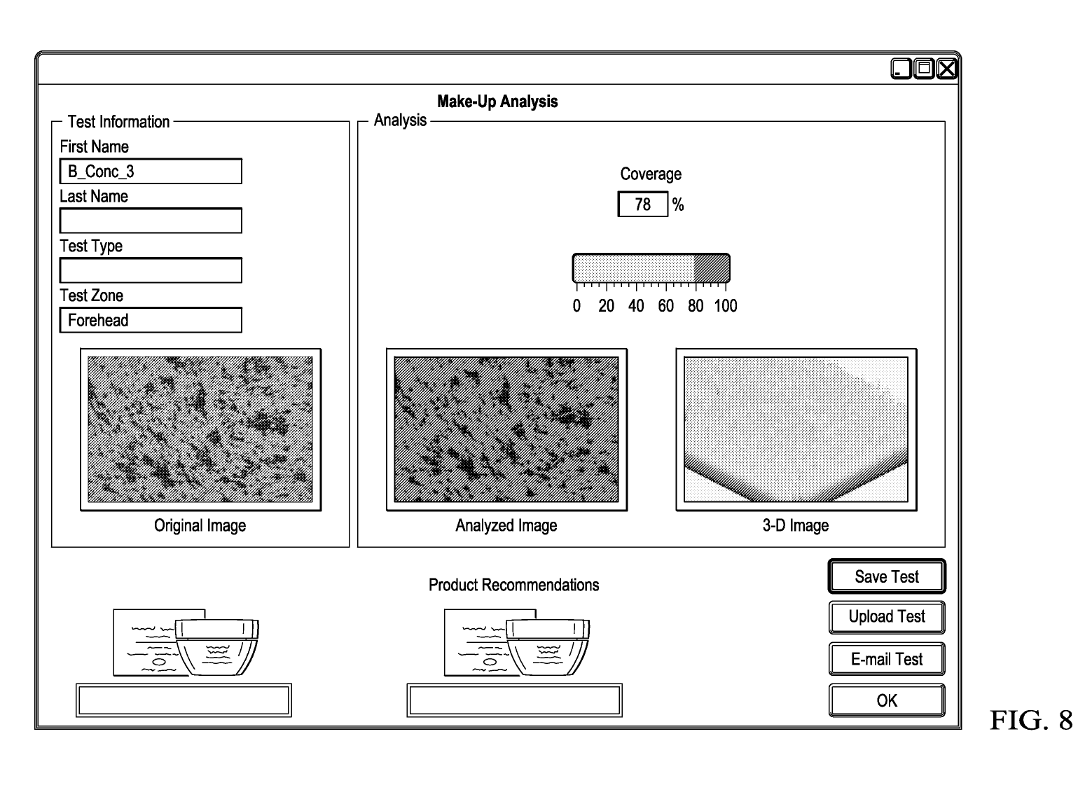

In another embodiment a tape strip is used to provide microanalysis of make-up or applied cosmetics on the skin. An adhesive strip is applied to the skin area covered with the cosmetic (FIG. 8). The strip is then taken off and placed into a reader system. The tape strip is then imaged and analyzed to observe the particulate behavior of the cosmetic of concern on the skin. Consistency and evenness of coverage, color, tone, clumping, fineness, and method of application (brush, finger, applicator device or stick) can be observed and analysis to recommend the ideal product and method of application of a cosmetic. An analysis and/or recommendation is then given to the patient.

The system may also include one or more image processing algorithms include one or more of the following: a particle count, a LUT (look up table) filter, a particle filter, a pattern recognition, a morphological determination, a histogram, a line profile, a topographical representation, a binary conversion, or a color matching profile. The results from analysis are interpreted as product purchase recommendation, health state of the biological sample, cosmetological diagnosis, aesthetic analysis, or any plan of action based from the subsequent data analysis. The data and results from the analysis are organized and stored into the database by grouping and matching of data classified as statistically similar. The interpreted results may be viewed in one or more of the following ways: a display panel on the collection node, an e-mail message, an SMS text message, or through searching/browsing of the database in a web browser. In another aspect, the method includes a micro-analysis of applied cosmetics is performed.

In other embodiments, the invention includes a method for capturing chemical substances of the skin including but not limited to living cells, dead cells, and adsorbed chemical substances on the surface. A method releasing a compound from an adhesive surface for detection in the presence of a skin marker. A method of preparing disposable adhesive sample collection devices. A method of activating a chemical composition resulting from folding the surface onto itself combing the collection zone with the chemical zone. Method of making a backing material unresponsive to light. A method of using a secondary test trip to combine a sample with a reactive chemical composition. An optical identifier for the purposes of quality control and calibration and anti-counterfeiting. A method of preventing counterfeiting by embedding a substance that emits a signature wavelength detectable by an optical reader, interrogated, then processed with a calibration algorithm. A method of embedding wicking fibers into an adhesive sample collection device for allowing flow into a lateral flow membrane. A method of activating an adhesive surface resulting from the mechanical shear of removing a protective file. A method of activating an adhesive surface resulting from the exposure of the underlying surface to an activating environment, fluid or light of a specified wavelength.

A method imaging the skin by stamping or pre-treating the skin with a florescent dye or reagent composition then taking a skin sample (tape strips, swabs). A device for imaging the skin mechanically resulting in the deposition of an impression that would appear as a 3D mirror image. A device for imaging a skin sample obtained mechanically through optically interrogation with a on board camera and illuminating LEDs. A group of skin markers indicative of one or more of the following individually, or in a group: protein, oxidized protein, oil (sebum), sugars, oxidized sugars, enzymes, collagenase enzymes (MMP family), ATP, Vitamins A-K, Water. A spatially oriented location designed to work with an imaging device such as a CCD or CMOS detector. An adhesive surface possessing embedded fluorescent dyes capable of absorbing broadband radiation for UV/Vis, IR near IR, far IR then emit at wavelengths specific to the properties of the dye.

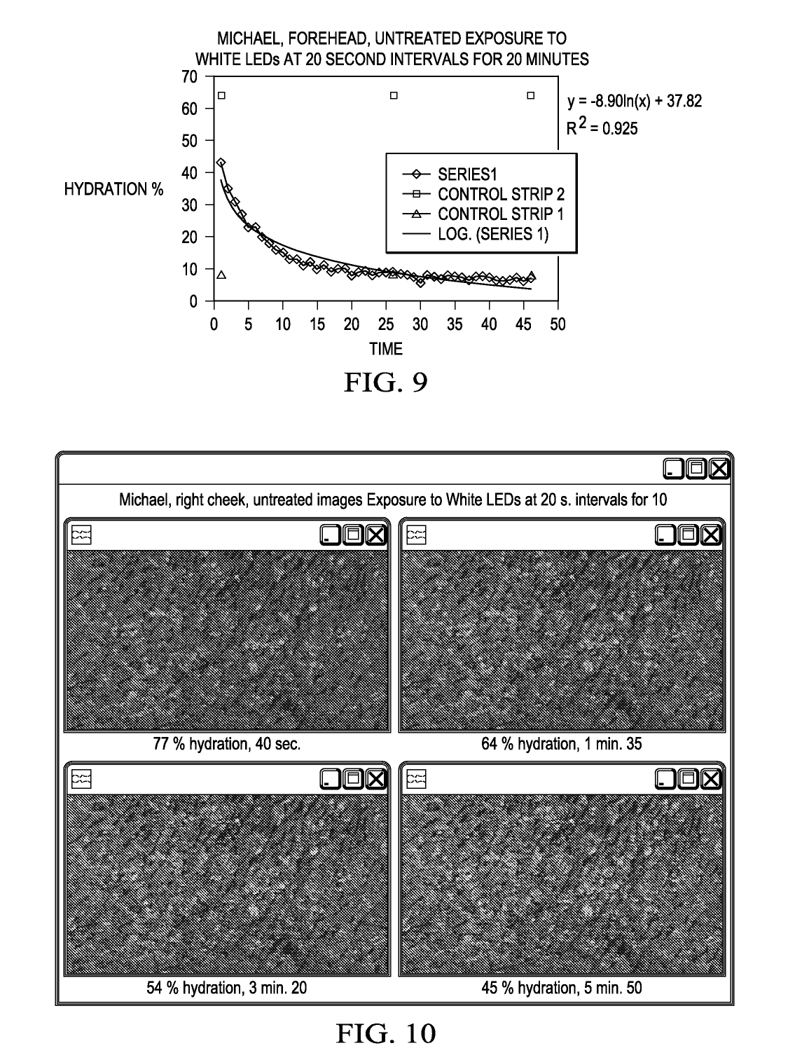

Hydration Retention Profiling: In certain embodiments an adhesive is used to collect a skin sample, and that sample is imaged over time. Analyzing logarithmic trend from the performance of the skin sampled at time intervals after tape stripping to assess how moisture is retained in the stratum corneum. The method can be used to look at the decrease in moisture levels over time, as moisture evaporates and the skin samples dries, and becomes lighter in appearance. The logarithmic curve that results from plotting the data points is show below in FIG. 9. FIG. 10 shows the images captured that are the basis for the curve in FIG. 9. The images show a clear trend of increasing whiteness in the skin flakes showing dehydration over time.

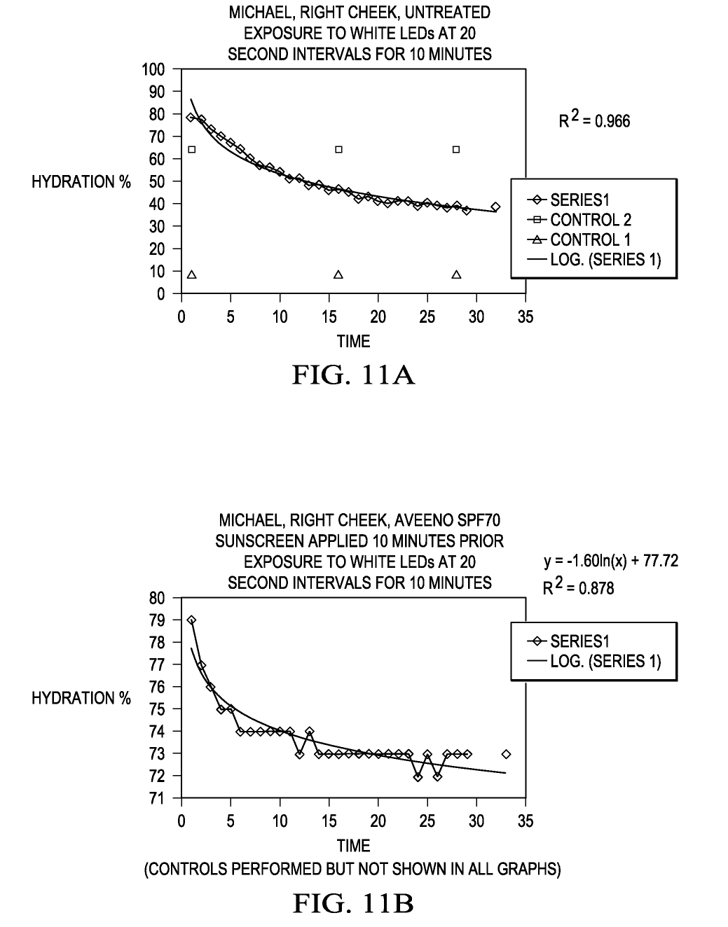

Different areas of the body, having different levels of skin hydration, will produce unique curves. FIG. 11A below shows the resultant curve from the skin sample from the cheek as compared to the forehead sample in FIG. 9.

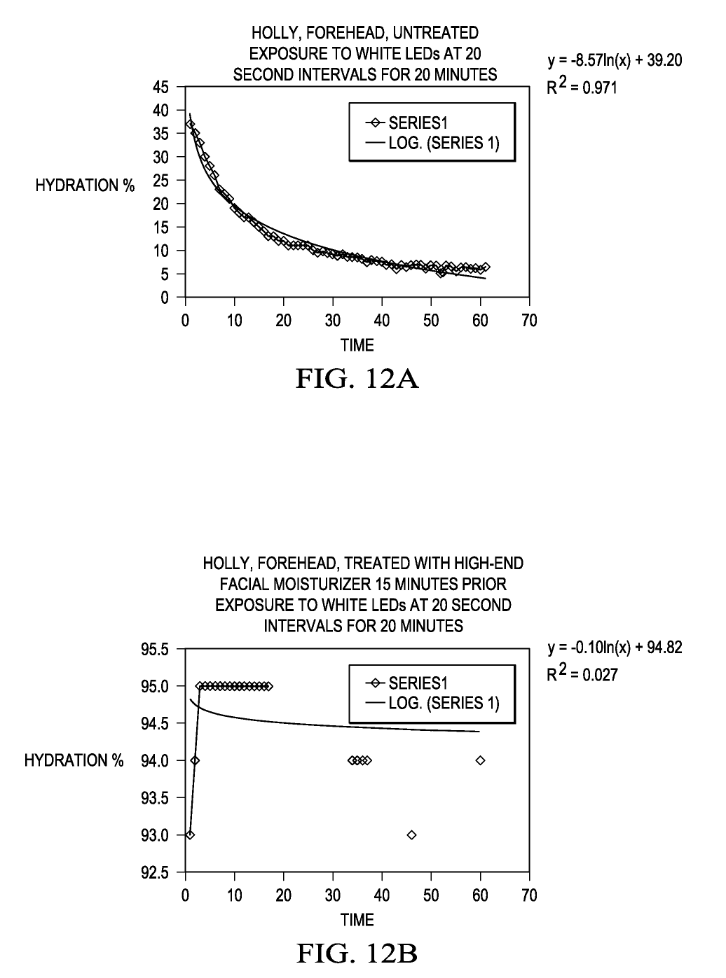

The above testing can also be used to measure the performance of a consumer product, such as a moisturizer. The same protocol above is carried out with a sample of skin previously treated with a moisturizing substance. The difference in the curve indicating the rate of dehydration of the skin then can then be used to judge the effectiveness of the moisturizer. FIG. 11B shows the application of a moisturizing sunscreen product and its effect on the curve. The curve shows the skin flakes were slower to dehydrate, and stayed ultimately at a higher level of hydration at the end of the curve. FIGS. 12A and 12B show the same principle with a moisturizer, and a different test subject.

This curve can be plotted and analyzed in different testing circumstances. In one example the imaging is done as above while the sample dehydrates. Then a hydrating factor is introduced such as an increase in humidity in the test strip environment. Subsequent images are then captured and the nature of the curve is used to characterize the rehydration performance of the sample.

Numerous factors can be introduced to the sample and used to see how they influence the performance of the skin by observing the changes in the logarithmic curve. These include processes such as heating the sample, dosing with difference wavelengths of light such as U.V. light.

Multiple adhesive samples can be taken from the same location on the skin and plotted in the same fashion as disclosed above. A basic hydration retention curve can be plotted and looked at to observe the difference in moisture retention at different depths of the skin surface.

The above testing protocols can be used together to observe how one factor influences another. For example, different products can be tested to examine their impact on hydration retention and rehydration along the logarithmic curve at different layers of the skin surface.

Products can also be looked at to observe their behavior under U.V. light. The effect of U.V. light on the skin behavior and how that is affected by U.V. light can be looked at as well. In one embodiment sunscreen efficacy is examined with this method. Sunscreen is placed on the skin and a sample is taken with the adhesive. The adhesive is then placed in the system and an image is captured under U.V. light. The amount of background fluorescence can be measured as an indicator of how much U.V. light is blocked by the sunscreen on the skin over time.

The instant invention further relates to methods and apparatuses for assessing skin and hair condition. The invention includes apparatuses designed to adapt a hand held consumer device into a diagnostic tool with the capability of collecting a biological sample, processing the biological sample, imaging the biological sample, sending the image to a remote server for analysis, the server then returned the analyzed image with a report on skin condition.

An apparatus designed to interface with a consumer device comprising a digital camera that integrates a sample method with imaging device, comprising a sample receiving area, a processing chamber, and a results chamber being either the sample receiving chamber or a separate collection area.

In one embodiment of the present invention the interface is universal to fit and integrate any consumer device. In other embodiment the interface is specific for the given device.

The apparatus has 3 basic functions and related subcomponents:

I. Area to integrate to the consumer device. The primary purpose of this component is for merging together the apparatus which attaches itself either temporarily or permanently to the consumer device and its primary purpose is for, and comprises: (i) a “docking station” type component where the consumer device is inserted into or placed upon the apparatus. The docking station may be a stationary platform or have the ability to be mobile. The station is designed to envelop the consumer device and therefore is generally larger than the device itself. The station can be designed to automate user interaction with the consumer device and the said apparatus in order to establish an automated “kiosk” where the presence of an operator is unnecessary, (ii) an adapter component which includes the entire apparatus and is mounted directly onto the consumer device. This adapter only mounts to the necessary parts of the consumer device and maintains a relatively smaller profile versus the consumer device itself. The adapter is designed to be amenable towards mobile applications and will not hinder the consumer device's mobility, (iii) an area to accept and/or process the sample. This component of the apparatus is designed to match the dimensions and overall form factor of the sample. An adhesive tape strip sample, for example, would contain a track-like mechanism to accept the shape of the tape strip and ensure it lies flat in the apparatus. For sampling skin directly, this component of the apparatus would consist of an enclosed box that is placed on the skin surface which isolates that portion of skin as the sample zone.

II. Area to interface with the digital camera. This usually consists of a lens and/or one or more light sources. The lens' purpose is to modify the focal length of the existing camera system to properly focus the sample. The lens type comprises a single macro, micro, or telephoto lens or a combination of these lens types. The light source, if required, consists of one or more LEDs of various types (UV, Infrared, white, or any other wavelength on the visible light spectrum). The LEDs illuminate the sample and are tuned to function optimally with the shutter speed, color filters, and other properties of the consumer camera. This interface allows the consumer device to function properly for the particular application.

The 3 subcomponents may be overlapping but are arranged such that upon collection of the sample it can be inserted into the device and imaged by operating the camera function on the consumer device.

The consumer device capability includes: (i) Cellular, Bluetooth, WiFi communication, (ii) GPS capability, (iii) One or more USB ports, (iv) Voice activated commands, (iv) Touch screen capability, (v) Vibration—Vibration prepares device for image capture or the vibration itself is analyzed, (vi) Using Open source application software to carry out testing steps.

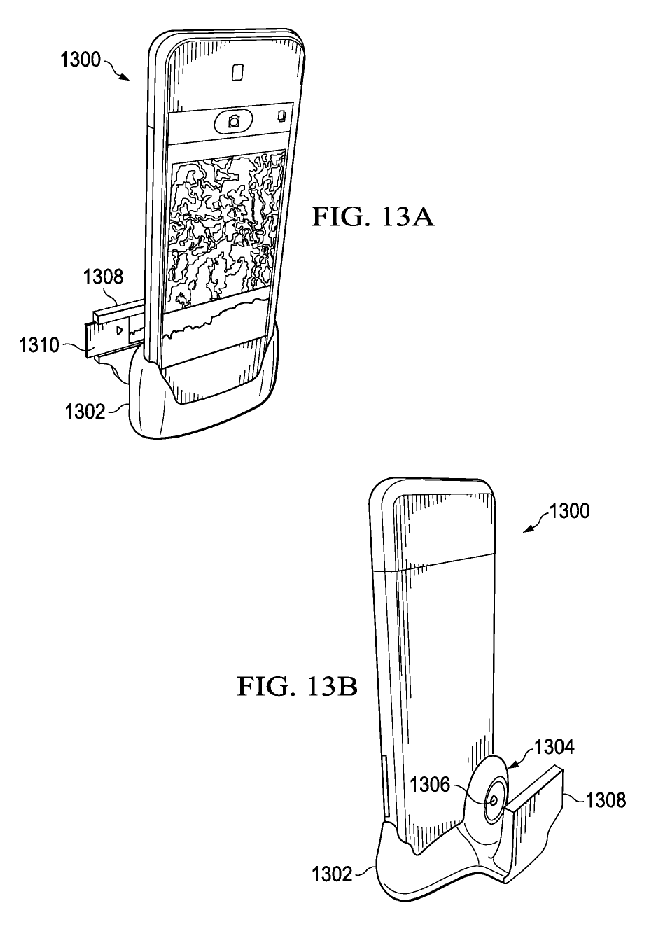

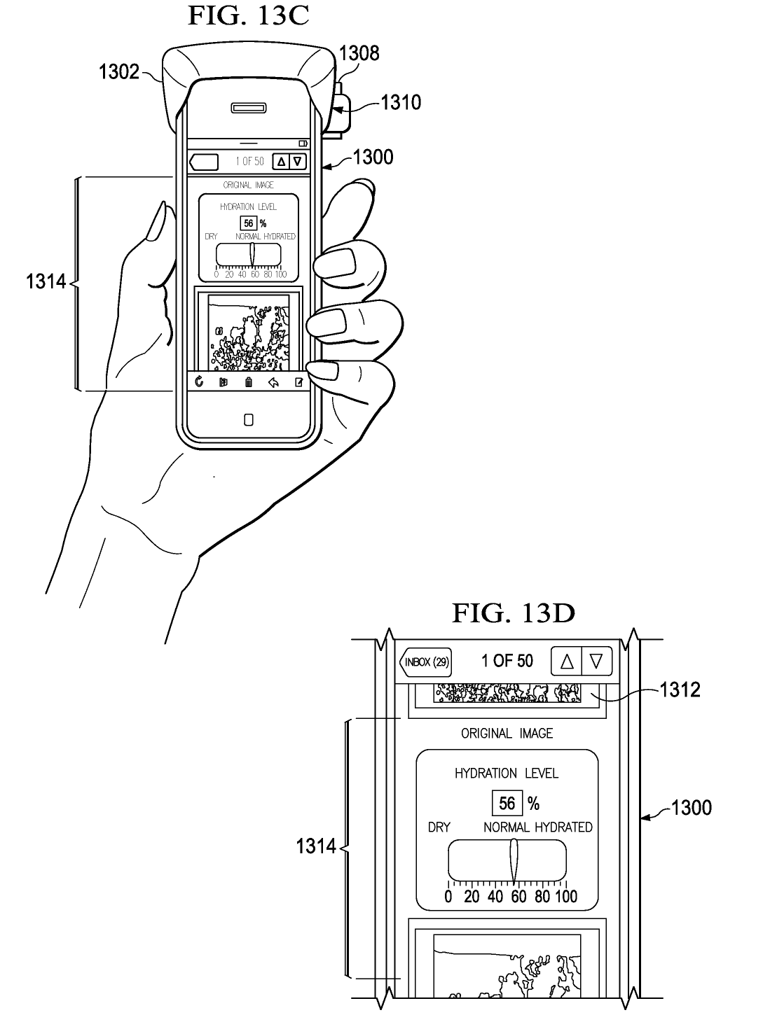

In one specific embodiment, an adaptor 1302 is attached to consumer device, such as an iPhone® 1300 (FIGS. 13A-13D). FIG. 13A is an image of phone 1300, apparatus 1302 with an adhesive strip 1310 inserted. FIG. 13B is a back view of phone 1300 placed in the apparatus 1302. The adaptor 1302 fits and attaches to the phone 1300 to hold all components in static orientation. The adaptor contains a magnifying lens 1304 that is in line with camera lens 1306 on the phone 1300 when the adaptor 1302 is placed onto the phone 1300. The camera lens 1306 on the phone 1300 and the magnifying lens 1304 on the adaptor 1302 are in line with a piece 1308 of the adaptor that contains a sample collection area, in this embodiment that accepts and holds and adhesive strip 1310. The adhesive strip 1310 is used to collect a sample of the skin by placing it against the skin, removing it, and placing into the slot 1308 on the adaptor 1302. Once placed, the phone 1300 is then used to collect an image of the tape strip 1310. The image is then sent by the phone 1300 to a server (not shown). The server then analyzes the image to assess skin condition. The analysis is then incorporated into a report image that contains the original skin sample image 1312 as well as analysis information such as graphs, colorimetric representations, and percentage levels 1314. The report is then sent back to the phone 1300 automatically by the server. The phone 1300 then receives the report directly communicating skin condition to the user based on the recently taken sample. FIG. 13C is an image of phone screen 1300 showing analysis results further scrolled down. Results (1314) show hydration level quantification based upon image analysis of the dry skin on the adhesive test strip 1310 placed in the holder 1302. FIG. 13D is an expanded view (close up) of the image shown in FIG. 13C.

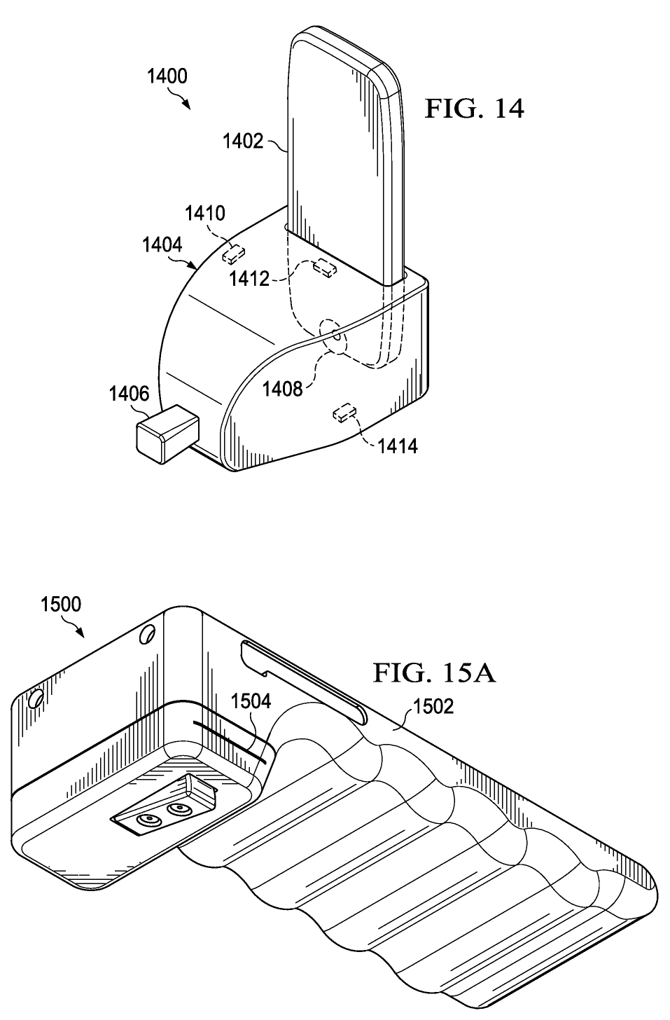

FIG. 14 depicts a design an enclosed consumer adaptive apparatus 1400. The apparatus comprises the consumer device 1402, the consumer adaptive apparatus 1404, the sample processing and accepting area 1406, a modifier lens in front of the consumer device digital camera lens 1408, a light emitting diode (LED) 1410. The LEDs may also be placed in 1412 and 1414. The consumer adaptive apparatus 1400 is closed to ambient light and contain one or a series of light emitted diodes (LED's). FIG. 14 shows a depiction of these LED's in an enclosed adaptive device 1400. There may be one LED 1410 is any location on the interior or a multitude of LEDs located at various points throughout the interior (1412 and 1414). These LED's can emit the entire spectrum of light including white light and ultraviolet light. LED's can be used to illuminate the sample area during image capturing. A multitude of images can also be taken under different LED wavelengths.

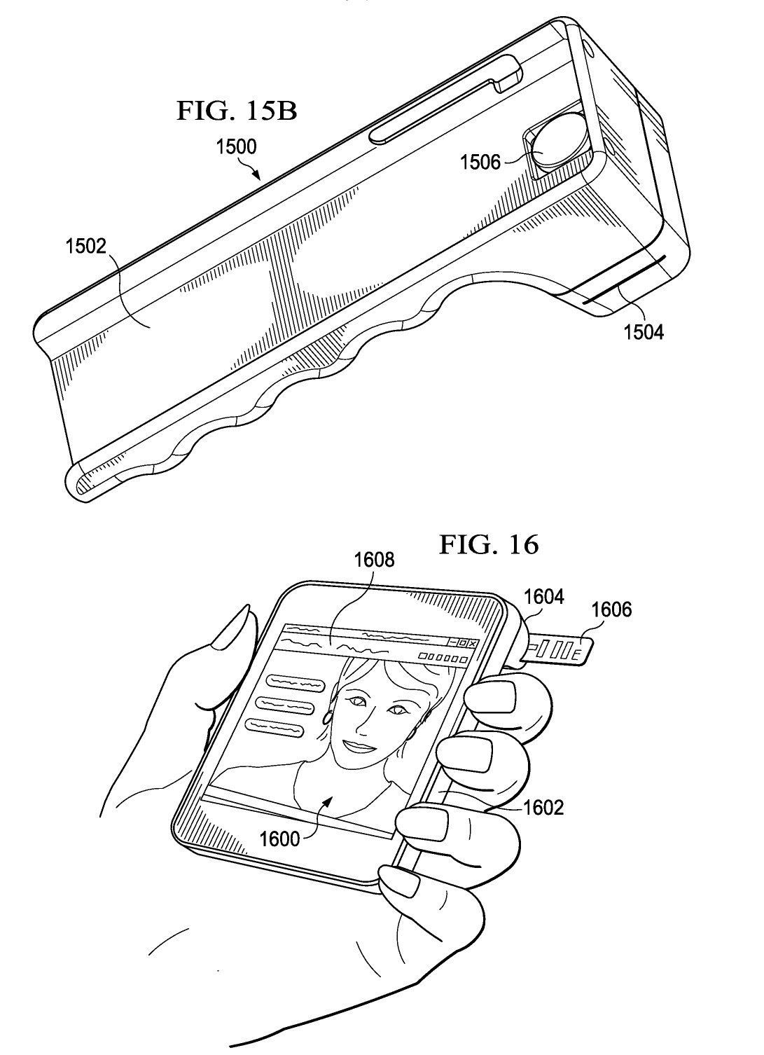

FIGS. 15A and 15B are CAD drawings of Smart phone apparatus modifiers 1500 for imaging test strips. The apparatus 1500 comprises a casing 1502 designed to fit iPhone 3G® model. In addition apparatus 1502 comprises an area 1504 for insertion of the tape strip sample. The housing 1502 also has modifier lens and white LED 1506. The lens 1506 in the apparatus 1500 modifies the focal length of the iPhone camera (not shown) to be able to clearly focus on the sample. A white LED illuminates the sample when it is inserted.

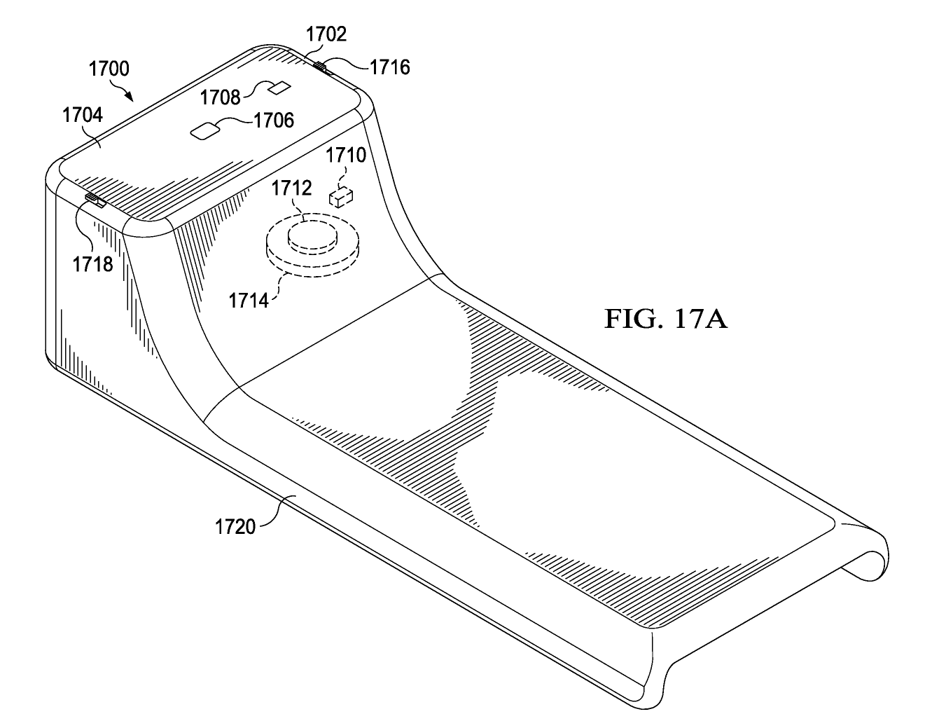

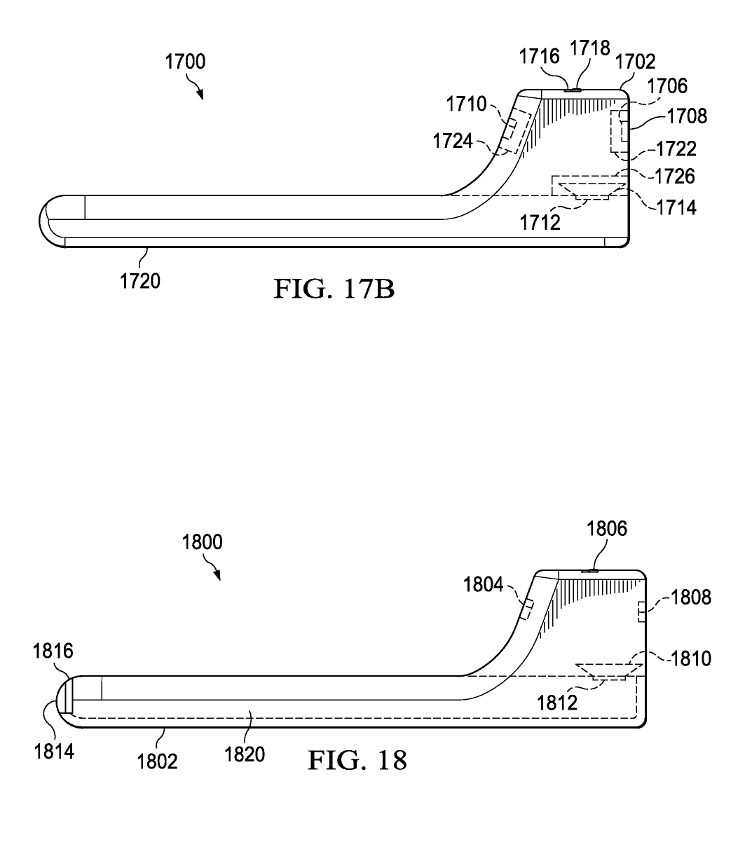

FIG. 16 is an apparatus 1602 with iPhone 1600 inserted and iPhone app 1608 on display. The apparatus 1602 comprises an area 1604 for insertion of the tape strip sample 1606. FIG. 17A is a Smart phone modifier 1700 for imaging skin directly. The apparatus 1700 is similar to apparatus in FIGS. 15A and 15B except the front face of apparatus 1704 is open to allow for direct image of skin. The drawing shows two light sources (1708 and 1710), two switches (1716 and 1718), a sensor 1706 and a modifier lens 1714. FIG. 17B is another angle of apparatus 1700 embodiment shown in FIG. 17A. This apparatus 1700 would allow for analysis of various skin conditions and features, such as moles, acne, skin diseases, pigmentation, and sun damage. In addition to skin, the device could analyze other features such as teeth, gums and hair. FIG. 18 is a Smart phone modifier 1800 with communication port interface 1814.

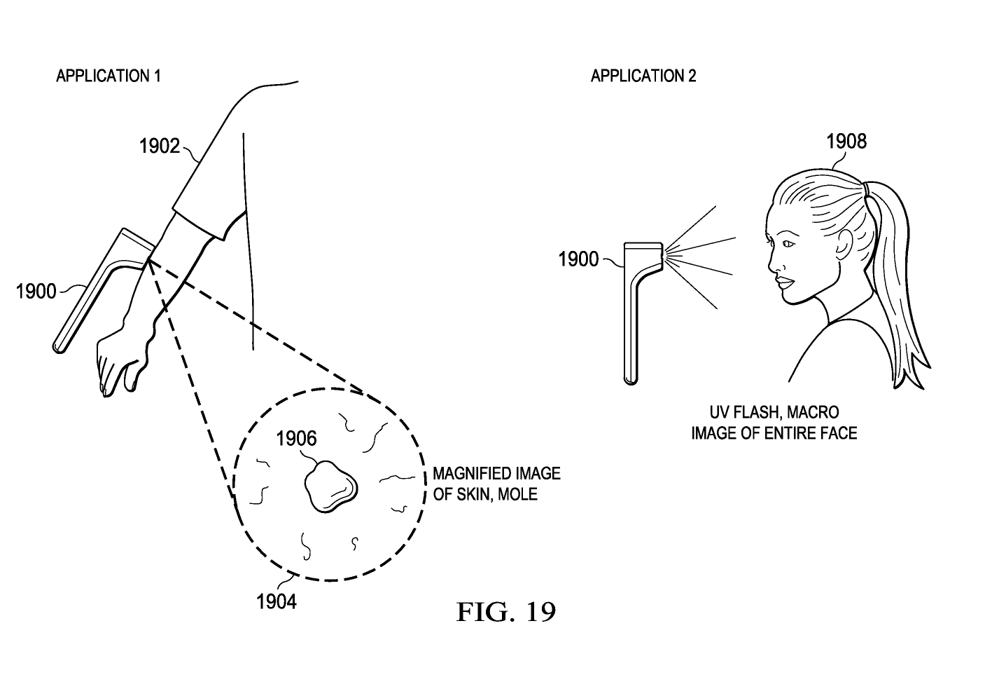

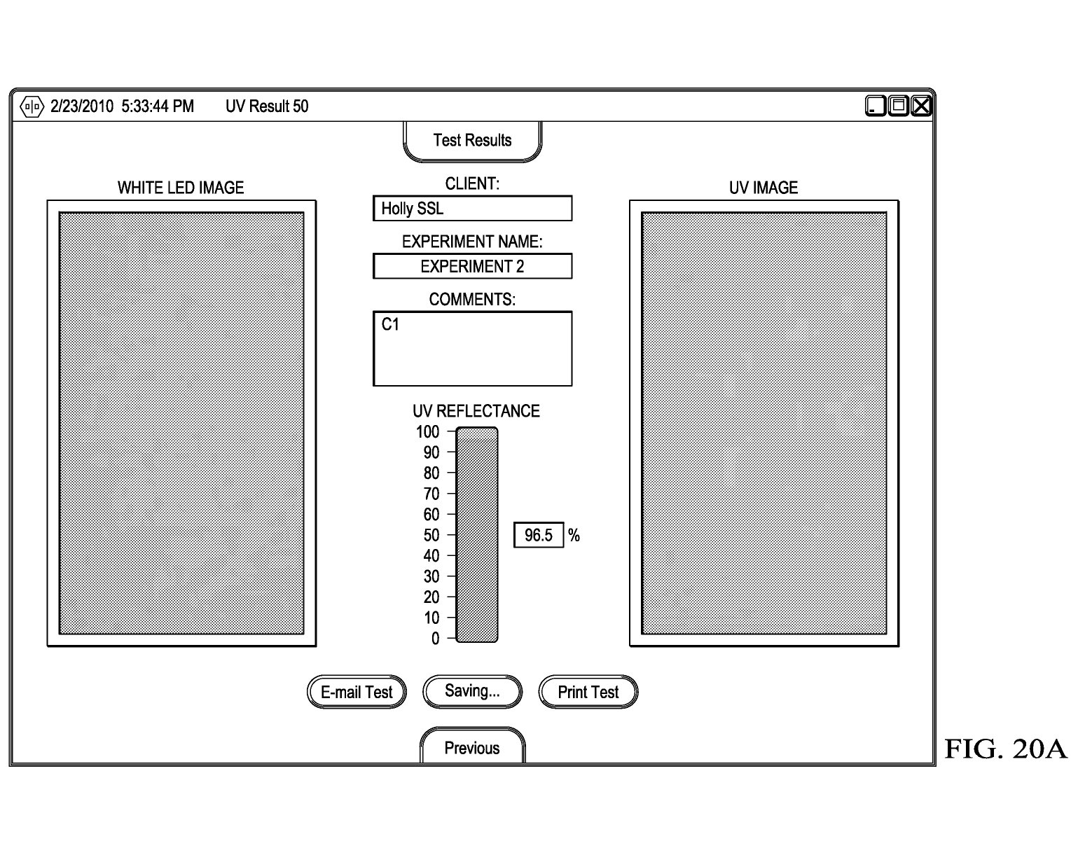

FIG. 19 shows two applications apparatus shown in FIGS. 17 and 18. Application 2 uses a UV LED light source 1900 to take an image of the subject's face 1908. This allows for viewing features below the surface of the skin, such as sun spots and skin damage;

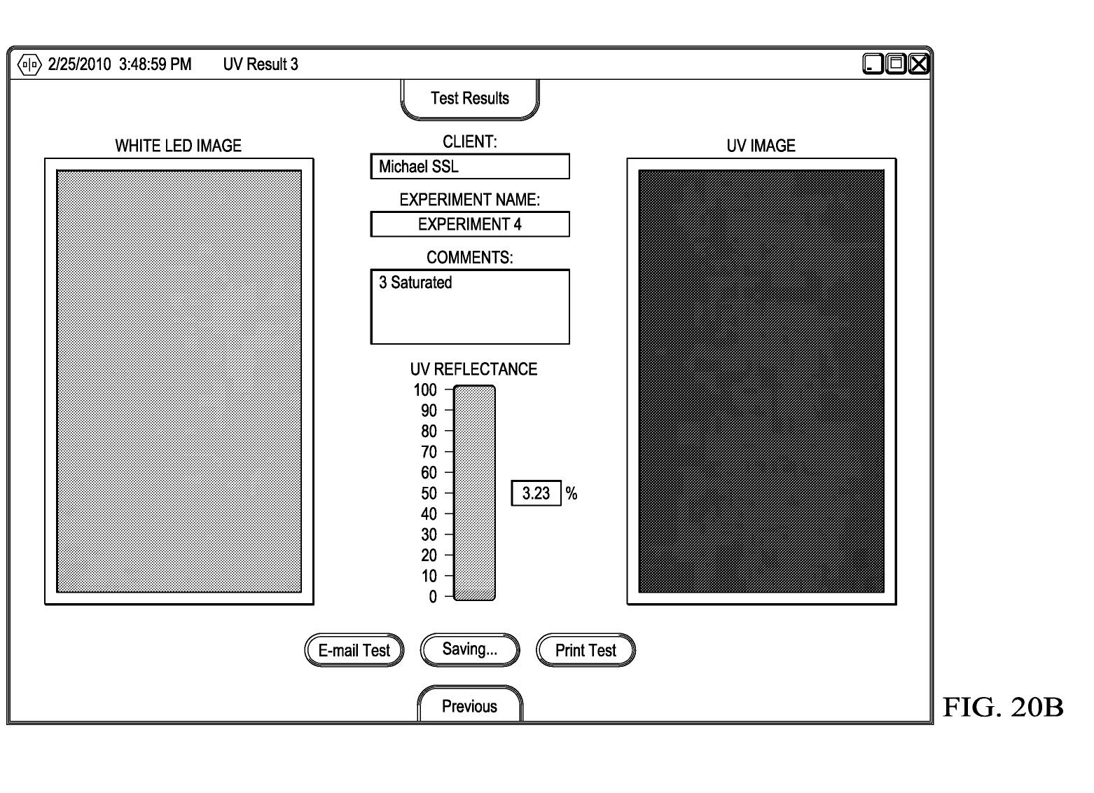

FIGS. 20A and 20B show UV/Sunscreen experimentation using apparatus with UV LEDs as light source and tape strips as medium;

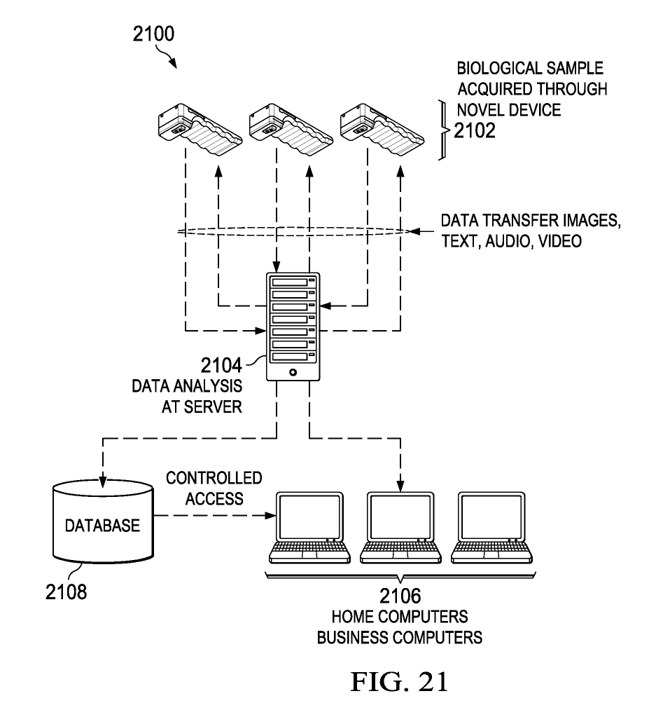

FIG. 21 is a schematic overview of mobile acquisition network 2100, where the novel apparatus 2102 is used to capture a biological/chemical sample and transmit it through the network. The data from the apparatus 2102 is transmitted to a central server 2104, from where it is transmitted for storage in a central database 2108 or to home and business computers 2106. The transmission is two-way from the server 2104 and the devices 2102 and from the server 2104 to the database 2108 and the computers 2106.

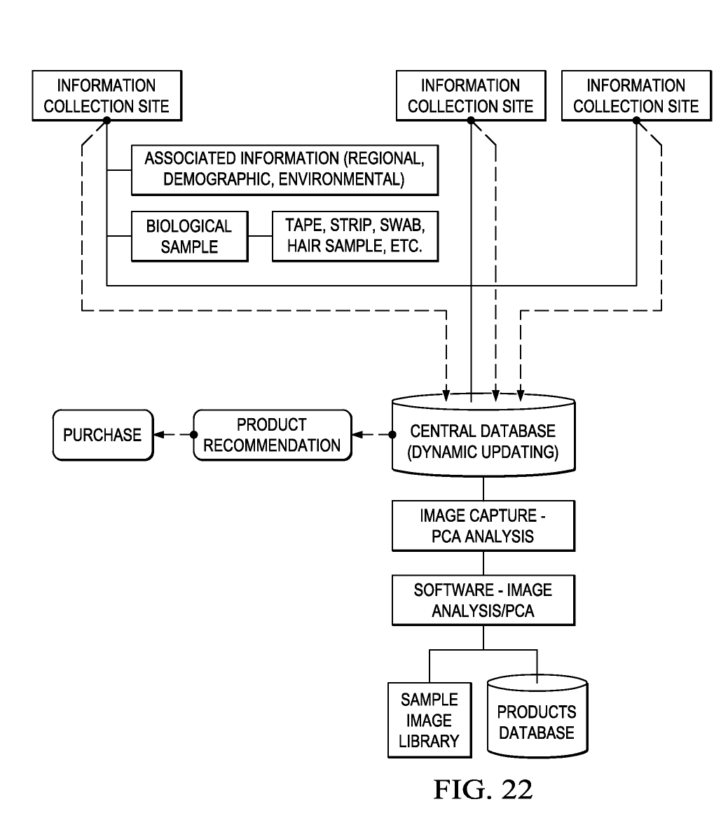

Method of Care and System: A central database receives and processes information from remotes nodes, the nodes sending information collected at the physical location of the remote node (FIG. 22). The central database receives and processes the information in a comparative fashion with data contained in the central database in and sends the result back to the node. Action is then taken at the node based on the result received from the central database. The remote collection (on site) of biological sample and instant or nearly instant analysis and product recommendation provide a strong incentive for a consumer to submit to non-invasive biological sample collection with the purpose of informing the consumer and guiding them to the right product choice. This could also be used to sample other biological media such as hair, sweat, or urine, and used in other many retail settings such as gymnasiums, vitamins stores or other health and fitness outlets, (food and beverage. etc).

System. In one embodiment, a non-invasive biological sample is taken from the skin of a consumer with an adhesive tape strip at a given location, such as a store counter or salon. The tape strip by its design gives an optical contrast of the skin sample or performs or is used to perform a biochemical assay and generate an optical signal. The tape strip is then placed into a reader, the reader being optical imaging hardware connected to software programmed to perform PCA and other processing and analysis on the image collected. The image and associated PCA data, along with other data collected by GPS or associated survey information such as regional, demographic, economic, or environmental information, are then uploaded to a central database for analysis and comparison with a library of skin images and data. The central database then analyzes the incoming data and draws an association based upon a database of products to be appropriate to improve the consumer skin condition based up the skin sample analysis (image 5). The product recommendation is then sent back to the remote location where the consumer is recommended the specific product for their skin condition. A subscription fee is charged the accessory of the database (the “recommender”) and the recommendation is made for the purpose of the selling the appropriate product to the consumer. Over time and with subsequent consumer visits, the same process is used to track actual product performance and provide tangible validation or recommend another product.

A further embodiment, the central database is uploaded to a handheld instrument that is at the sampling location. The sample is taken and test medium is placed into the reader. The reader then performs the image and PCA analysis and database comparison on the local hard drive. The instrument then gives at an instant product recommendation.

The present invention also includes a method of doing business comprising, a system of data collection nodes, comprising: a computational device capable of optically interrogating biological samples and obtaining user survey data; a software implemented user interface which facilitates interaction between user and computational device and serves as means for data collection, transmission, and analysis; a communication protocol to transmit data between collection node and a main server, including uploading of data to main server from collection node and downloading of data from main server to collection node; a data collection method in which data from the collection nodes is compiled, processed, and stored into a dynamically updated database on the main server, which can be searched and browsed through a web browser or software program interface. In one example, the biological samples involve living or dead tissue, such as dead skin cells or open wounds. In one example, the biological samples are test devices used to obtain a sample of tissue, such as swabs or tape strips. In another example, the biological samples are processed prior to being optically interrogated through photonic, electromagnetically radiating, chemical, biochemical, or electrical. In another example, the data collected includes images of the biological samples and survey information obtained through a questionnaire.

In another example, data is transmitted via broadband wireless or landline connection to an FTP, TCP, or e-mail server. The system may also include survey data, e.g., demographic information, product preferences, and expectations from product use, behavioral tendencies, or general preferences related to the product category or biological sample collection. The system may collect images in grayscale and/or color format and the images and survey data may be transmitted synchronously or independently of one another. In another example, data analysis occurs through one or more of the following software implemented methods: image processing algorithms which analyze images for biological, chemical, morphological, or aesthetic parameters, statistical methods to identify patterns and correlations between the data, and expert opinion or recommendation by an expert panel. The expert panel may include but not is not limited to scientists, medical professional's estheticians, marketing specialists, business developers, or any professional qualified to provide an expert opinion or recommendation based on the data. In one example, the statistical method is PCA (principle component analysis).

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

United States Patent Application No. 20090075250: Environmental Sampling and Testing Method.

What is claimed is:

1. A method of testing a surface sample comprising the steps of:
collecting the surface sample with a sampling device;
capturing at least one digital image with a digital camera of a consumer device of the sample selected from at least one of before, during or after the sample interacts with the one or more agents;
transmitting the at least one digital image of the sample over a network to be analyzed by a remote server; and
analyzing the transmitted the at least one digital image using an image processing software on the remote server.

2. The method of claim 1, further comprising the steps of inserting the sampling device into the consumer device or an adaptor linked to the consumer device, wherein the consumer device comprises a digital camera, and optionally provides a GPS location, a vibration capability, an image storage memory, and wherein the adaptor comprises a modifier lens to adjust a focal length of the consumer device camera lens, and one or more LEDs positioned to illuminate the sample.

3. The method of claim 1, further comprising the optional steps of:
retransmitting the analyzed images back to the consumer device to report a test result; and
providing electronic media marketing materials comprising health and beauty care product, salon, and service recommendations to the consumer device.

4. The method of claim 1, wherein the sampling device comprises one or more agents disposed to interact with the surface sample.

5. The method of claim 1, wherein the sample comprises at least one of skin, nail, hair, biological fluid, one or more chemical species or any combinations thereof.

6. The method of claim 1, wherein the consumer device further comprises one or more membranes selected from nitrocellulose, UVPE, PVDF, hydrophobic membranes known to those skilled in the art of immunosorbent assays.

7. The method of claim 1, wherein the sampling device comprises an optional optical barcode, a radio frequency (RF) ID tag or combinations and modifications thereof.

8. The method of claim 1, wherein the sampling device comprises a disposable card comprised from cardboard or vinyl sized for a cartridge.

9. The method of claim 1, wherein the sampling device comprises a background with a random colored pattern for security, calibration, and test validation interpretable by an algorithm processing digital signal from the digital camera.

10. The method of claim 1, wherein the sampling device is adapted to remove skin cells, proteins, and oils, capture enzymes from a stratum corneum for chemical testing.

11. The method of claim 1, wherein the sampling device is selected to maximize the imaging capabilities of an imaging device through minimizing, maximizing or mixing reflective, absorbance, and transmittance properties.

12. The method of claim 1, wherein the sampling device optionally comprises one of a preloaded region with an analyte specific reagent, such as a synthetic receptor, releases a dye upon experiencing a change in pressure, comprises a chemical composition for indicating health conditions or allows flow to a subsequent surface.

13. The method of claim 1, wherein the consumer device is selected from the group consisting of digital cameras, digital camcorders, mobile phones, camera phones, PDA devices, Blackberry devices, and laptop computers.

14. The method of claim 1, wherein the consumer device is a mobile phone.

15. The method of claim 1, wherein the LEDs comprise UV, Infrared, white or any other wavelength on the visible light spectrum.

16. The method of claim 1, wherein the LEDs are programmed to function optimally from one or more properties of the digital camera of the consumer device comprising speed, color filters or combinations thereof.

17. An apparatus for integration with one or more consumer devices selected from the group consisting of digital cameras, digital camcorders, mobile phones, camera phones, PDA devices, Blackberry devices, and laptop computers to detect a sample captured on a test strip, the apparatus comprising:
a stationary or mobile housing, a docking station or a combination thereof to enclose or integrate with the consumer device temporarily or permanently, therein the housing comprises a sample receiving port;
one or more modifier lenses, wherein the modifier lenses adjust the focal length of a digital camera of the consumer device to focus the sample; and
one or more lights to illuminate the sample, wherein the digital camera is capable of capturing one or more images the sample.

18. The apparatus of claim 17, wherein the lenses comprise a single macro, a micro, a telephoto lens or a combination thereof.

19. The apparatus of claim 17, wherein the lights are defined further as comprising one or more LEDs that emit UV, Infrared, white or any other wavelength on the visible light spectrum.

20. The apparatus of claim 17, wherein the lights are defined further as comprising one or more LEDs that are programmed to function optimally from one or more properties of the digital camera of the consumer device comprising speed, color filters or combinations thereof.

21. A system for assessing a skin and associated health care conditions comprising:
a consumer device capable of capturing a digital image;
an apparatus for integrating with the one or more consumer devices comprising:
a stationary or mobile housing, docking station or a combination thereof to enclose or integrate the consumer device temporarily or permanently;
a sampling area for directly imaging one or more regions of the skin or directly imaging a sampling device, wherein the sampling area comprises one or more sensor, light sources, and switches;
a modifier lens to adjust a focal length of the consumer device camera lens, and one or more LEDs for illuminating the sample;
a port or an interface for transmitting one or more digital images to a remote server; and
a remote server for analyzing and optionally retransmitting the analyzed image to the consumer device, wherein the server comprises an image processing and analysis software to analyze the transmitted digital image.

22. The system of claim 21, wherein the system optionally provides electronic media marketing materials comprising health and beauty care products, salon, and service recommendations to the consumer device

23. The system of claim 21, wherein the consumer device is selected from the group consisting of digital cameras, digital camcorders, mobile phones, camera phones, PDA devices, Blackberry devices, and laptop computers.

24. The system of claim 21, wherein the consumer device provides a GPS location and vibration capability.

25. The system of claim 21, wherein the consumer device is a mobile phone.

26. The system of claim 21, wherein the sampling device comprises an optional optical barcode, a radio frequency (RF) ID tag or combinations and modifications thereof.

27. The system of claim 21, wherein the sampling device comprises a disposable card comprised from cardboard or vinyl sized for a cartridge.

28. The system of claim 21, wherein the sampling device comprises a background with a random colored pattern for security, calibration, and test validation interpretable by an algorithm processing digital signal from the digital camera.

29. The system of claim 21, wherein the sampling device is adapted to remove skin cells, proteins, and oils, capture enzymes from a stratum corneum for chemical testing.

30. The system of claim 21, wherein the sampling device is selected to maximize the imaging capabilities of an imaging device through minimizing, maximizing or mixing reflective, absorbance, and transmittance properties.

31. The system of claim 21, wherein the sampling device optionally comprises one of a preloaded region with an analyte specific reagent, such as a synthetic receptor, releases a dye upon experiencing a change in pressure, comprises a chemical composition for indicating health conditions or allows flow to a subsequent surface.
